(19) United States
(12) Patent Application Publication
(10) Pub. No.: US 2017/0201998 A1
(43) Pub. Date: Jul. 13, 2017

(54) RADIO COMMUNICATION SYSTEM, RADIO COMMUNICATION APPARATUS AND RADIO COMMUNICATION METHOD

(71) Applicant: FUJITSU LIMITED, Kawasaki-shi (JP)

(72) Inventors: Hiroki AKIYAMA, Kawasaki (JP); Hitoshi YOKOYAMA, Kawasaki (JP)

(73) Assignee: FUJITSU LIMITED, Kawasaki-shi (JP)

(21) Appl. No.: 15/472,883

(22) Filed: Mar. 29, 2017

Related U.S. Application Data
(63) Continuation of application No. PCT/JP2014/076224, filed on Sep. 30, 2014.

(51) Int. Cl. H04W 72/08; H04W 16/14; H04W 72/04

(52) U.S. Cl. CPC H04W 72/082; H04W 72/0453; H04W 16/14; H04W 72/042; H04W 72/0413; H04W 88/06

(57) ABSTRACT

The present invention provides a radio communication system including a radio communication apparatus that can wirelessly communicate at frequencies in a predetermined licensed band and an unlicensed band, and a base station. The base station includes a first processor configure to manage operating states of frequencies in the unlicensed band and notify the radio communication apparatus of operating states of frequencies in the unlicensed band at a frequency in the predetermined licensed band. The radio communication apparatus includes a second processor configured to receive operating states of frequencies in the unlicensed band from the base station at a frequency in a predetermined licensed band, select an unused frequency in the unlicensed band as an operation candidate frequency and transmit a transmission request to the base station at the operation candidate frequency in the unlicensed band.

### CROSS-REFERENCE TO RELATED APPLICATION

This application is a continuation application of International Application PCT/JP2014/076224, filed on Sep. 30, 2014, and designated the U.S., the entire contents of which are incorporated herein by reference.

### FIELD

The present invention relates to a radio communication system, a radio communication apparatus and a radio communication method.

### BACKGROUND

In recent years, access to the Internet using mobile terminals is becoming more and more frequent and traffic of packet data communication is on the rapid increase. As one way to effectively use frequency bands, the standardization organization 3GPP (Third Generation Partnership Project) is proposing carrier aggregation (CA). CA is a technique for achieving speed enhancement of communication using carriers in a plurality of frequency bands. As one method of CA, use of, for example, a 5 GHz frequency band which calls for no licensing such as Wi-Fi (Wireless Fidelity) is being proposed in addition to an LTE (Long Term Evolution) frequency band (2 GHz band) which calls for licensing. Licenses are granted to communication carriers by, for example, the Ministry of Internal Affairs and Communications in Japan. A frequency band, use of which calls for a license will be referred to as a “licensed band” hereinafter. A frequency band which is available without calling for any license for use will be referred to as an “unlicensed band” hereinafter.

FIG. 1 is a diagram illustrating an example of a system that carries out carrier aggregation using an unlicensed band. FIG. 1 illustrates base stations of a communication carrier company A and a base station of a communication carrier company B. In FIG. 1, a solid line represents a coverage area of a licensed band of each base station and a broken line represents a coverage area of an unlicensed band of each base station. The coverage area of each base station is called a “cell.”

First, executing CA using an unlicensed band presupposes that communication is established between a base station and a terminal at a predetermined frequency in a licensed band. When there is a demand for improvement of a communication speed, CA is started and a resource of a 5 GHz unlicensed band is secured as an extended band.

However, since everybody can use an unlicensed band, when an unlicensed band is used by CA, operating frequencies in the unlicensed band may overlap between a base station and a base station of another communication carrier or a privately installed base station, causing radio wave interference. For example, in the example illustrated in FIG. 1, when the company A is developing a service using a predetermined frequency in an unlicensed band ahead of the others, if the company B newly starts a service using the same frequency in the unlicensed band, interference occurs.

Interference is likely to occur on a boundary of cells of respective base stations. For example, when a terminal is located in the periphery of a boundary between the cell of the base station of the company A and the cell of the base station of the company B, the terminal receives a radio signal at the same frequency in the unlicensed band from the base station of the company A and the base station of the company B, and radio wave interference occurs.

For example, as a method of controlling interference in an unlicensed band using Wi-Fi, a newly installed base station of the company B searches for radio waves in the periphery when the apparatus starts. When the base station of the company B senses a radio wave at a frequency of the unlicensed band of company A, the base station of the company B transmits a radio wave at a frequency in an unlicensed band different from that of company A so as to prevent collision between channels of the unlicensed band.

### PATENT DOCUMENT

[Patent document 1] National Publication of International Patent Application No. 2014-500685
[Patent document 2] Japanese Patent Application Laid-Open No. 2013-192220
[Patent document 3] National Publication of International Patent Application No. 2013-534395

However, the aforementioned method for a newly installed base station to search for peripheral radio waves and control radio wave interference in an unlicensed band may involve, for example, the following problems.

FIG. 2 is a diagram illustrating an example of radio wave interference occurring in an unlicensed band. When the base station of the company A is providing a service at a frequency in the unlicensed band ahead of the others and a base station of the company B is newly installed and starts a service at a frequency of the unlicensed band, the base station of the company B searches for peripheral radio waves in the periphery.

However, when the base station of the company B is located at a position outside the reach of the radio wave from the base station of the company A, the base station of the company B is unable to sense the radio wave at the frequency of the unlicensed band sent from the base station of the company A. For this reason, the base station of the company B may transmit a radio wave at the same unlicensed band frequency as that of the base station of the company A. When the base station of the company A and the base station of the company B transmit radio waves at the same unlicensed band frequency, interference may occur at a terminal located within the reach of radio waves from both the base station of the company A and the base station of the company B, preventing the terminal from correctly carrying out communication.

### SUMMARY

One aspect of the present invention is a radio communication system including a radio communication apparatus that can carry out radio communication at frequencies in a predetermined licensed band and an unlicensed band and a base station that can carry out radio communication with the radio communication apparatus at the frequencies in the predetermined licensed band and the unlicensed band. The base station includes a first processor configure to manage operating states of frequencies in the unlicensed band and notify the radio communication apparatus of operating states of frequencies in the unlicensed band at a frequency in the predetermined licensed band. The radio communication apparatus includes a second processor configured to receive operating states of frequencies in the unlicensed band from the base station at a frequency in a predetermined licensed band, select an unused frequency in the unlicensed band as an operation candidate frequency and transmit a transmission request to the base station at the operation candidate frequency in the unlicensed band.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a system that carries out carrier aggregation using an unlicensed band;

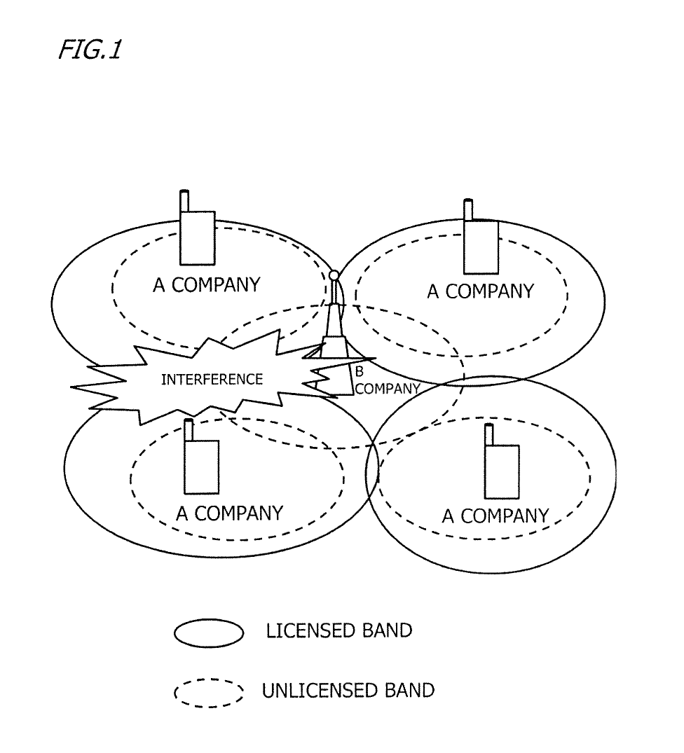

FIG. 2 is a diagram illustrating an example of radio wave interference occurring in the unlicensed band;

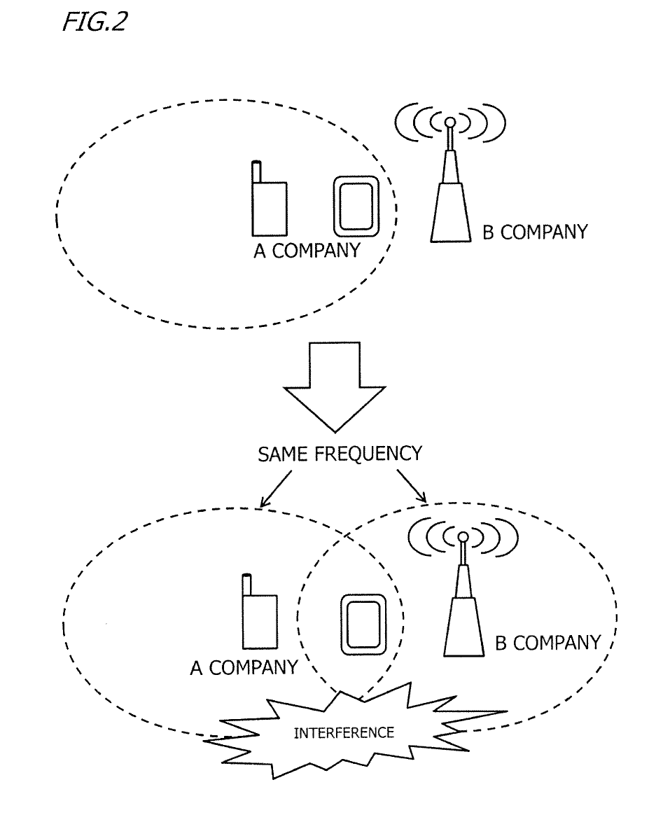

FIG. 3 is a diagram illustrating an example of a system configuration of a radio communication system according to a first embodiment;

FIG. 4 is a diagram illustrating an example of a processing sequence in the radio communication system according to the first embodiment;

FIG. 5 is a diagram illustrating an example of a hardware configuration of UE;

FIG. 6 is a diagram illustrating an example of a functional configuration of UE;

FIG. 7 is a diagram illustrating an example of a hardware configuration of a base station;

FIG. 8 is a diagram illustrating an example of a functional configuration of the base station;

FIG. 9 is a diagram illustrating an example of information included in capability information;

FIG. 10 is a diagram illustrating an example of information included in a RACH trigger;

FIG. 11 is a diagram illustrating an example of information included in a RACH trigger response;

FIG. 12 is an example of a flowchart of CA execution determination processing executed by UE;

FIG. 13 is an example of a flowchart of unlicensed band interference determination processing executed by UE.

FIG. 14 is an example of a flowchart of unlicensed band connection determination processing executed by a serving base station;

FIG. 15 is an example of a flowchart of unlicensed band connection determination processing executed by a peripheral base station;

FIG. 16 is an example of a flowchart of transmission determination processing executed by UE;

FIG. 17 is an example of a flowchart of unlicensed band connection stop processing executed by the serving base station;

FIG. 18 is a diagram illustrating an example of a processing sequence in a radio communication system according to a second embodiment;

FIG. 19 is an example of a flowchart of CA execution determination processing executed by the serving base station;

FIG. 20 is a diagram illustrating an example of a processing sequence in a radio communication system according to a third embodiment;

FIG. 21 is a diagram illustrating an example of a format of an unlicensed transmission disabling request according to the third embodiment;

FIG. 22 is a diagram illustrating an example of a processing sequence in a radio communication system according to a fourth embodiment;

FIG. 23 is a diagram illustrating an example of information included in capability information according to the fourth embodiment;

FIG. 24 is an example of a flowchart of unlicensed band interference determination processing executed by UE according to the fourth embodiment;

FIG. 25 is an example of a flowchart of transmission determination processing executed by UE according to a fifth embodiment.

### DESCRIPTION OF EMBODIMENTS

Hereinafter, embodiments of the present invention will be described based on the accompanying drawings. Configurations of the following embodiments are illustrated as examples and the present invention is not limited to the configurations of the embodiments.

### First Embodiment

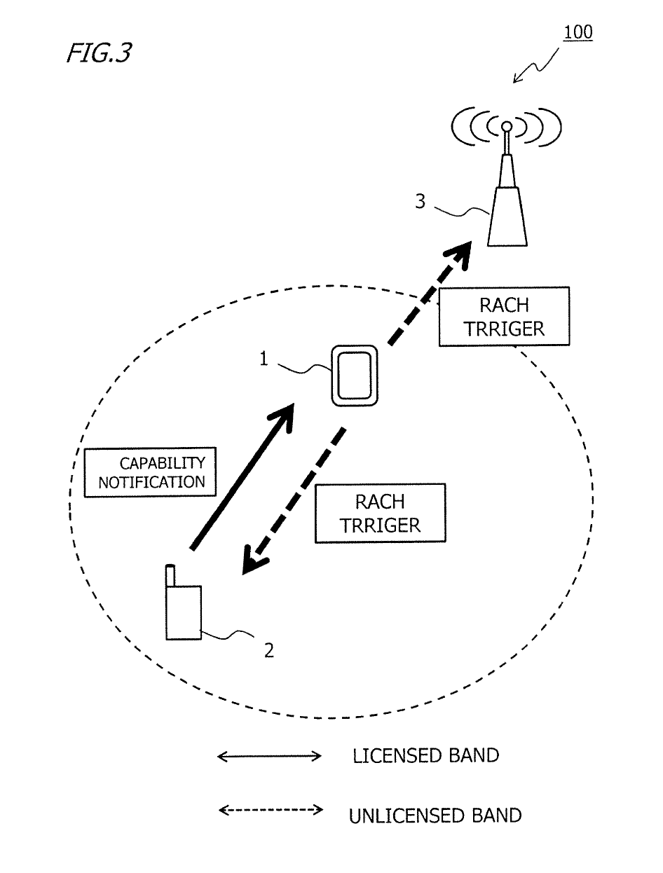

FIG. 3 is a diagram illustrating an example of a system configuration of a radio communication system 100 according to a first embodiment. The radio communication system 100 includes a UE 1, a serving base station 2 which is a base station of a carrier contracted by the UE 1 and used by UE 1 for communication, and a peripheral base station 3 which is a base station of a carrier not contracted by the UE 1 and located in the vicinity of the serving base station 2. The UE 1 is assumed to be located at a place within the reach of radio waves from both the serving base station 2 and the peripheral base station 3.

Suppose the UE 1, the serving base station 2 and the peripheral base station 3 are all able to communicate at unlicensed band frequencies. The UE 1 and the serving base station 2 are able to communicate at frequencies in a predetermined licensed band assigned to a corresponding communication carrier. Since the peripheral base station 3 belongs to a communication carrier different from that of the serving base station 2, the peripheral base station 3 is unable to use the frequency in the predetermined licensed band used for communication between the serving base station 2 and the UE 1.

In the first embodiment, the UE 1 receives capability information including an operating state of the unlicensed band from the serving base station 2. When executing CA using the unlicensed band, the UE 1 selects an operation candidate frequency from among frequencies in an unused unlicensed band based on the capability information and determines the presence or absence of radio wave interference at the operation candidate frequency in the unlicensed band by searching for radio waves at the current position and inquiring from each base station about whether or not the operation candidate frequency can be used. When it is determined that there is no radio wave interference at the operation candidate frequency, the UE 1 transmits a transmission request to the serving base station 2 at the operation candidate frequency.

For example, the serving base station 2 and the peripheral base station 3 are not always located within the reach of their respective radio waves, and may be unable to sense radio waves emitted from each other. Even when the serving base station 2 and the peripheral base station 3 are not located within the reach of radio waves, if both radio waves arrive at the UE 1, the UE 1 is able to sense radio waves transmitted from serving base station 2 and the peripheral base station 3 respectively. The UE 1 searches for radio waves or inquires from each base station about whether or not the operation candidate frequency can be used, and can thereby detect radio wave interference more accurately and avoid radio wave interference when an unlicensed band frequency is used.

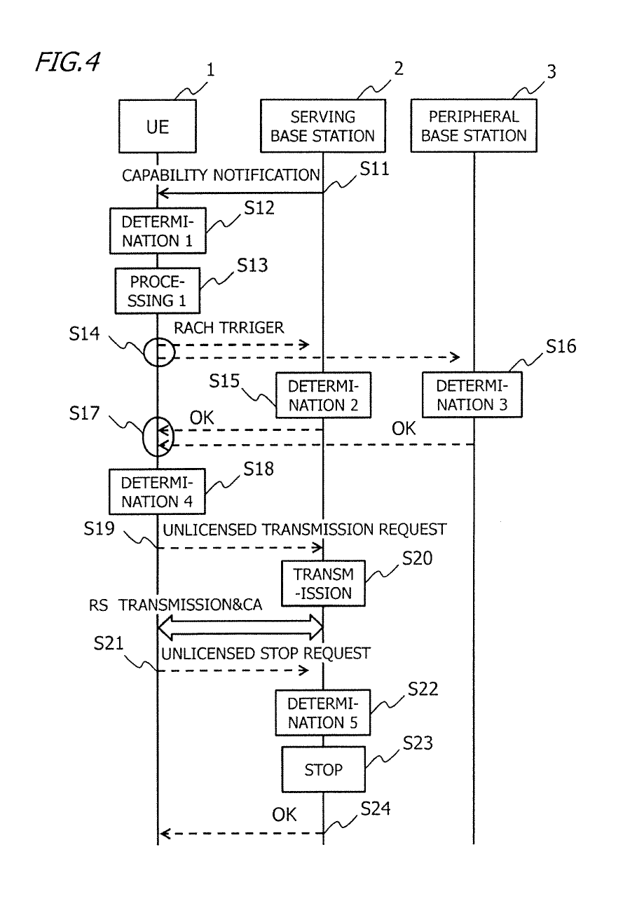

FIG. 4 is a diagram illustrating an example of a processing sequence at the radio communication system 100 according to the first embodiment. As a premise, suppose that communication is currently underway between the UE 1 and the serving base station 2 at a predetermined frequency of a licensed band. In FIG. 4, communication at the licensed band frequency is illustrated by straight line arrows. Communication at an unlicensed band frequency is illustrated by broken line arrows.

In S11, the serving base station 2 periodically notifies the UE 1 of capability information by broadcasting at a predetermined licensed band frequency. The capability information includes information on available frequency bands in the unlicensed band of the serving base station 2 and information on an operating state of the unlicensed band frequency. The capability information is notified at, for example, a 1-second interval.

In S12, taking the opportunity of reception of the capability information, the UE 1 performs CA execution determination processing (determination 1) of determining whether or not to execute CA. The CA execution determination processing is performed based on an amount of data stored in a communication buffer and an application attribute used for communication of the UE 1.

In S13, when execution of CA is determined in the CA execution determination processing, the UE 1 performs unlicensed band interference determination processing (processing 1) of selecting an operation candidate frequency from among frequencies in the unlicensed band. In the unlicensed band interference determination processing, the UE 1 selects an operation candidate frequency from among the frequencies in the unlicensed band based on the capability information, senses the operation candidate frequency and determines the presence or absence of interference with other base stations.

In S14, when there is no radio wave interference at the operation candidate frequency, the UE 1 transmits an operation request at the operation candidate frequency. In the first embodiment, a RACH (Random Access CHannel) trigger is used as an operation request. The RACH trigger is transmitted by broadcasting at the operation candidate frequency of the unlicensed band. Since the RACH trigger is transmitted by broadcasting, the RACH trigger reaches the serving base station 2 and the peripheral base station 3.

In S15, the serving base station 2 that receives the RACH trigger performs unlicensed band connection determination processing (determination 2) of determining whether or not connection is possible at the operation candidate frequency demanded by the RACH trigger.

In S16, the peripheral base station 3 that receives the RACH trigger performs unlicensed band connection determination processing (determination 3) of determining whether or not connection is possible at the operation candidate frequency of the unlicensed band demanded by the RACH trigger.

In S17, the serving base station 2 and the peripheral base station 3 transmit an OK response or an NG response respectively in response to the RACH trigger at the unlicensed band operation candidate frequency and the UE 1 receives the respective RACH trigger responses. In S18, the UE 1 performs transmission determination processing (determination 4) of determining whether or not transmission of a transmission request at the operation candidate frequency is possible based on the RACH trigger responses from the serving base station 2 and the peripheral base station 3. In the transmission determination processing, if no NG response is included in the received RACH trigger responses, transmission of a transmission request at the unlicensed band operation candidate frequency is determined.

In S19, the UE 1 transmits an unlicensed transmission request to the serving base station 2 at the unlicensed band operation candidate frequency.

In S20, the serving base station 2 that receives the unlicensed transmission request starts to transmit a reference signal (RS) at the unlicensed band operation candidate frequency and starts a CA service using the unlicensed band.

In S21, the UE 1 determines ending of CA using the unlicensed band and transmits an unlicensed stop request at the unlicensed band operating frequency.

In S22, the serving base station 2 receives the unlicensed stop request and performs unlicensed stop determination processing (determination 5) of determining stoppage of transmission at the unlicensed band operating frequency. In the unlicensed stop determination processing, the serving base station 2 confirms that there is no UE 1 using the unlicensed band operating frequency other than the UE 1.

In S23, when there is no UE 1 using the unlicensed band operating frequency other than the UE 1, the serving base station 2 stops transmission of a reference signal (RS) at the unlicensed band operating frequency. In S24, the serving base station 2 returns an OK response to the UE 1.

<Apparatus Configuration>

(UE)

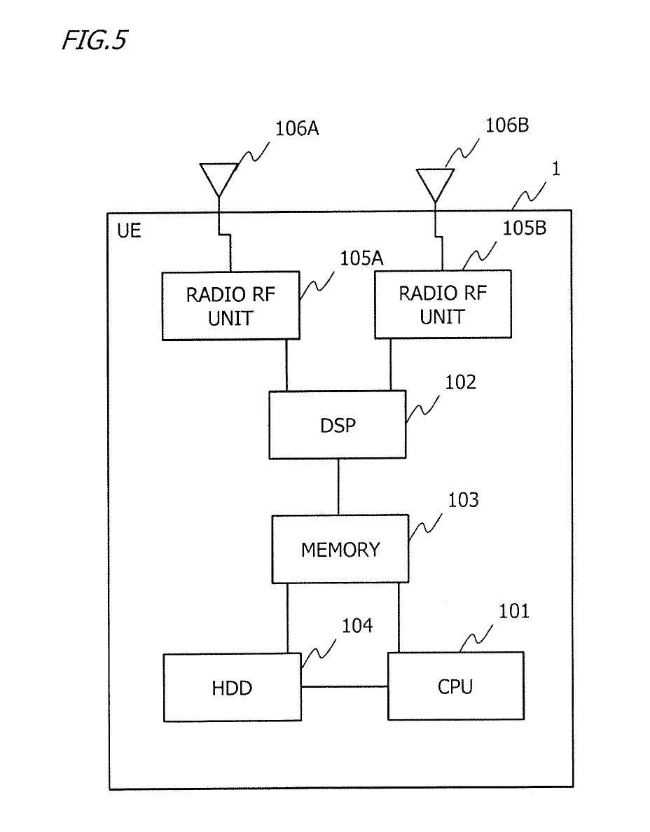

FIG. 5 is a diagram illustrating an example of a hardware configuration of the UE 1. The UE 1 is a mobile terminal such as a smartphone, a tablet terminal, a mobile phone terminal or a notebook PC (personal computer). However, the UE 1 is not limited to a mobile terminal, and can be a stationary terminal such as a desktop PC.

The UE 1 is provided with a CPU (central processing unit) 101, a DSP (digital signal processor) 102, a memory 103, an HDD (hard disk drive) 104, radio RF (radio frequency) units 105A and 105B, and antennas 106A and 106B as hardware components.

The radio RF units 105A and 105B are connected to the antennas 106A and 106B, respectively. The radio RF units 105A and 105B convert radio signals received via the antennas 106A and 106B to electric signals, output the electric signals to the CPU 101 or convert electric signals inputted from the CPU 101 to radio signals and transmit the radio signals via the antennas 106A and 106B. The radio RF unit 105A performs, for example, processing on communication under a radio communication scheme such as LTE (Long Term Evolution) using a licensed band. The radio RF unit 105B performs, for example, processing on communication under a wireless communication scheme such as WiFi using an unlicensed band.

The DSP 102 performs baseband processing on electric signals inputted/outputted to/from the radio RF unit 105A and the radio RF unit 105B. More specifically, the DSP 102 performs digital/analog conversion, modulation and demodulation of digital signals and coding and decoding or the like.

The memory 103 is, for example, a RAM (random access memory). The memory 103 provides, as a main storage apparatus, a storage region and a work region to load a program stored in the HDD 104 or a storage apparatus used as a buffer. The memory 103 is a volatile storage apparatus.

The HDD 104 stores, as an auxiliary storage apparatus, an OS (operating system), various programs and data used by the CPU 101 upon execution of each program. When the UE 1 is a mobile terminal such as a smartphone, a flash memory may be provided instead of the HDD 104. The HDD 104 stores, for example, a CA execution program. The CA execution program is a program to carry out carrier aggregation using an unlicensed band frequency.

The CPU 101 performs various kinds of processing by loading the OS and various application programs stored in the HDD 104 into the memory 103 and executing them. The number of CPUs 101 is not limited to one but a plurality of CPUs 101 can be provided.

Note that the hardware configuration of the UE 1 is not limited to the one illustrated in FIG. 5, but any change such as addition, substitution or deletion can be made as appropriate. For example, the UE 1 can be provided with a display, a touch panel, a speaker, a microphone, a camera or the like in addition to the configuration illustrated in FIG. 5. The UE 1 is an example of the “radio communication apparatus.”

In the illustrated example in FIG. 5, different radio RF units are provided for the licensed band and the unlicensed band, but the radio RF units are not limited to this. For example, using a voltage controlled oscillator (VCO), one radio RF unit may process signals of the licensed band and the unlicensed band while adjusting the frequency band.

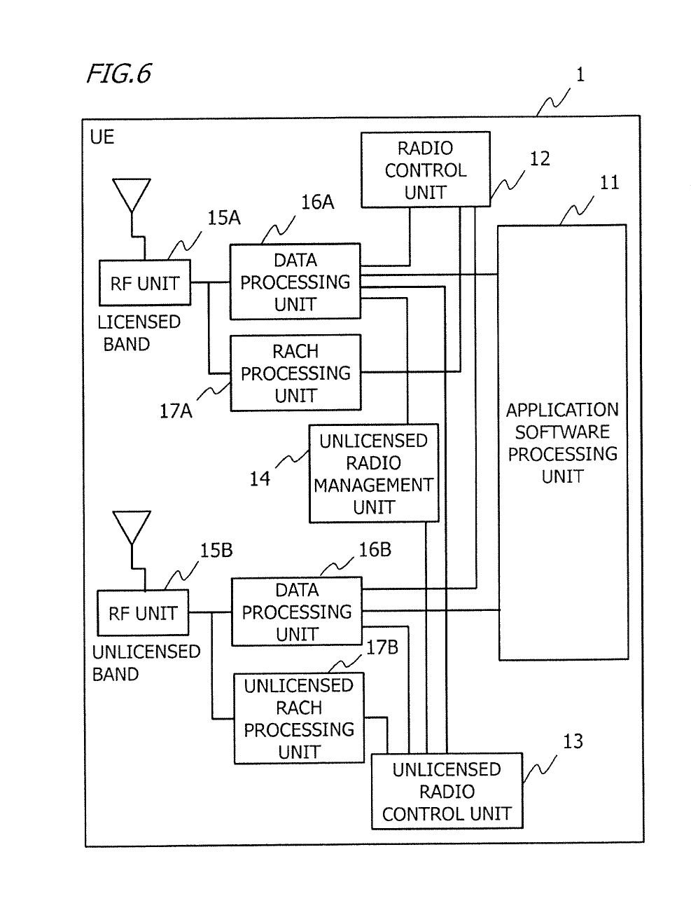

FIG. 6 is a diagram illustrating an example of a functional configuration of the UE 1. As the functional configuration, the UE 1 includes an application software processing unit 11, a radio control unit 12, an unlicensed radio control unit 13, an unlicensed radio management unit 14, RF units 15A and 15B, data processing units 16A and 16B, a RACH processing unit 17A and an unlicensed RACH processing unit 17B.

The RF unit 15A, the data processing unit 16A and the RACH processing unit 17A correspond to a functional configuration that processes signals at a licensed band frequency. The RF unit 15B, the data processing unit 16B and the RACH processing unit 17B correspond to a functional configuration that processes signals at an unlicensed band frequency.

The RF units 15A and 15B respectively convert a radio signal to an electric signal. The RF units 15A and 15B correspond to the radio RF units 107A and 107B, respectively.

The data processing units 16A and 16B, and the RACH processing units 17A and 17B correspond to a functional configuration achieved by processing by the DSP 102. The data processing units 16A and 16B extract data from electric signals obtained from radio waves received at the licensed band and unlicensed band frequencies respectively or convert data to electric signals. The data processing units 16A and 16B respectively input/output application communication data to/from the application software processing unit 11.

The data processing unit 16A extracts capability information from the electric signal inputted from the RF unit 15A and outputs the extracted capability information to the unlicensed radio control unit 13.

The data processing unit 16B receives an input of the unlicensed transmission request from the unlicensed radio control unit 13, converts the transmission request to an electric signal and transmits the electric signal via the RF unit 15B. The data processing unit 16B extracts a response to the unlicensed transmission request from an electric signal inputted from the RF unit 15B and outputs the unlicensed transmission request to the unlicensed radio control unit 13.

The RACH processing unit 17A and the unlicensed RACH processing unit 17B respectively extract data to be stored at a predetermined position in a radio frame from an electric signal obtained from received radio waves at licensed band and unlicensed band frequencies or store the data at a predetermined position of the radio frame and convert the data to electric signals.

The unlicensed RACH processing unit 17B creates, according to an instruction from the unlicensed radio control unit 13, an RACH trigger including information on an operation candidate frequency selected by the unlicensed radio control unit 13 and transmits the RACH trigger via the RF unit 15B. The unlicensed RACH processing unit 17B receives a response to the RACH trigger via the RF unit 15B and outputs the information included in the response to the RACH trigger to the radio control unit 13.

The radio control unit 12 corresponds to a functional configuration achieved by execution of an OS module or middleware associated with radio communication processing by the CPU 101. The radio control unit 12 controls the data processing unit 16A, the RACH processing unit 17A and the data processing unit 16B in communication at the licensed band frequency.

The application software processing unit 11 corresponds to a functional configuration achieved by the CPU 101 executing a predetermined application. When the application performs communication, the application software processing unit 11 inputs/outputs data to/from the data processing unit 16A and the data processing unit 16B.

The unlicensed radio control unit 13 and the unlicensed radio management unit 14 correspond to functional configurations achieved by the CPU 101 executing a CA execution program. The unlicensed radio management unit 14 monitors a communication buffer amount of the data processing unit 16A, that is, a communication processing load at the licensed band frequency. Upon receiving a read instruction from the unlicensed radio control unit 13, the unlicensed radio management unit 14 outputs the communication buffer amount of the data processing unit 16A to the unlicensed radio control unit 13.

The unlicensed radio control unit 13 performs CA execution determination processing, unlicensed band interference determination processing and transmission determination processing. Upon receiving an input of capability information from the data processing unit 16A, the unlicensed radio control unit 13 starts CA execution determination processing. In the CA execution determination processing, the unlicensed radio control unit 13 acquires the communication buffer amount of the data processing unit 16A from the unlicensed radio management unit 14 and determines execution of CA using the unlicensed band frequency depending on whether or not the communication buffer amount is greater than a predetermined threshold.

Note that in the CA execution determination processing, execution of CA may be determined based on the application type instead of the communication buffer amount of the data processing unit 16A. When execution of CA using the unlicensed band frequency is determined based on the application type, the unlicensed radio management unit 14 monitors the application type executed by the application software processing unit 11. Upon receiving an input of capability information, the unlicensed radio control unit 13 acquires the application type from the unlicensed radio management unit 14 and determines the execution of CA using the unlicensed band frequency depending on whether or not an application is of the application type for which CA execution is predetermined. The application type for which CA execution is predetermined is, for example, an application of a service for which a real-time property is demanded. Examples of the service for which a real-time property is demanded include a voice communication service.

Upon determining, through CA execution determination processing, execution of CA using the unlicensed band frequency, the unlicensed radio control unit 13 performs unlicensed band interference determination processing. In the unlicensed band interference determination processing, the unlicensed radio control unit 13 determines an operation candidate frequency from among unlicensed band frequencies based on the capability information. After determining the unlicensed band operation candidate frequency, the unlicensed radio control unit 13 instructs the unlicensed RACH processing unit 17B to transmit a RACH trigger at the operation candidate frequency.

Upon receiving an input of a response to the RACH trigger from the unlicensed processing unit 17B, the unlicensed radio control unit 13 performs transmission determination processing. In the transmission determination processing, the unlicensed radio control unit 13 monitors the response of the received RACH trigger until the next random access is made and determines transmission of a transmission request at the operation candidate frequency based on the presence or absence of an NG response. Upon determining transmission of the transmission request at the operation candidate frequency, the unlicensed radio control unit 13 outputs an unlicensed transmission request for the serving base station 2 to the data processing unit 16. The data processing unit 16 transmits an unlicensed transmission request for the serving base station 2 at the operation candidate frequency via the RF unit 15B.

Upon receiving a CA stop instruction from, for example, an application, the unlicensed radio control unit 13 outputs the unlicensed stop request to the data processing unit 16B. The unlicensed stop request is transmitted to the serving base station 2 at the operating frequency in the unlicensed band via the data processing unit 16B and the radio RF unit 15B. Examples of the opportunity of transmission of the unlicensed stop request include that the communication buffer amount of the data processing unit 16A falls to or below a predetermined threshold and an input of a stop instruction from a user.

(Base Station)

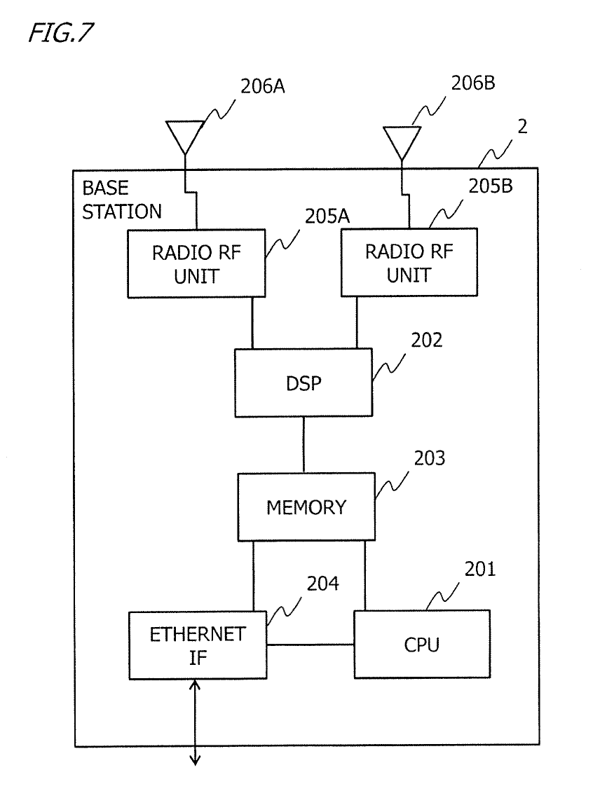

FIG. 7 is a diagram illustrating an example of a hardware configuration of the base station. The serving base station 2 and the peripheral base station 3 have substantially the same configuration, and therefore when no particular distinction is made therebetween, both base stations will be described as the “base station 2.” The base station 2 may be a large-sized base station or a small-sized base station such as a “femto cell.”

The base station 2 is provided with a CPU 201, a DSP 202, a memory 203, an Ethernet (registered trademark) interface 204, radio RF units 205A and 205B, and antennas 206A and 206B as hardware components. Since the CPU 201, DSP 202, memory 203, radio RF units 205A and 205B, and antennas 206A and 206B are similar to the CPU 101, DSP 102, memory 103, radio RF units 105A and 105B, and antennas 106A and 106B in FIG. 5, description thereof will be omitted.

The radio RF unit 205A and the antenna 206A perform processing associated with radio waves having licensed band frequencies. The radio RF unit 205B and the antenna 206B perform processing associated with the radio waves having unlicensed band frequencies.

The Ethernet interface 204 is an interface to input/output data to/from a network connected to, for example, a higher apparatus.

The memory 203 stores an OS and a base station CA execution program. The base station CA execution program is a program to execute CA using an unlicensed band.

Note that the hardware configuration of the base station 2 is not limited to that illustrated in FIG. 7, but any change such as addition, substitution or deletion can be made as appropriate. For example, the base station 2 may be provided with an auxiliary storage apparatus such as an HDD in addition to the configuration illustrated in FIG. 7. The serving base station 2 is an example of the “base station.” The peripheral base station 3 is an example of the “other base station.”

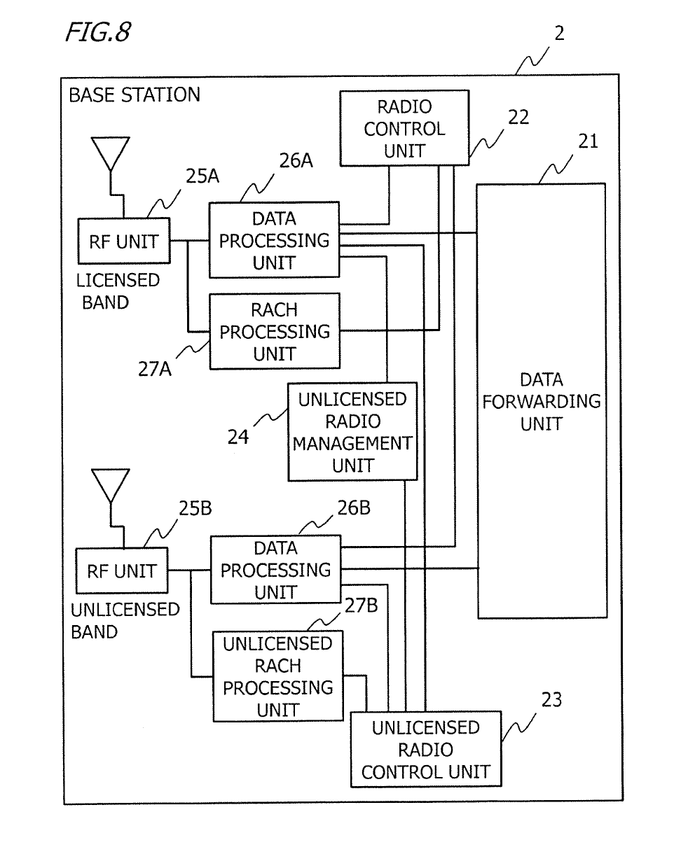

FIG. 8 is a diagram illustrating an example of a functional configuration of the base station 2. As the functional configuration, the base station 2 includes a data forwarding unit 21, a radio control unit 22, an unlicensed radio control unit 23, an unlicensed radio management unit 24, RF units 25A and 25B, data processing units 26A and 26B, a RACH processing unit 27A, and an unlicensed RACH processing unit 27B. The radio control unit 22, RF units 25A and 25B, data processing units 26A and 26B, RACH processing unit 27A and unlicensed RACH processing unit 27B overlap the radio control unit 12, RF units 15A and 15B, data processing units 16A and 16B, RACH processing unit 17A, and unlicensed RACH processing unit 17B in FIG. 6 respectively, and therefore description thereof will be omitted. Note that since the unlicensed radio management unit 24 does not operate in the first embodiment, description in the first embodiment will be omitted.

The data processing unit 26A receives an input of capability information from the unlicensed radio control unit 23, converts the capability information to an electric signal and transmits the electric signal via the RF unit 25A. The unlicensed RACH processing unit 27B extracts a RACH trigger from an electric signal inputted from the RF unit 25B and outputs the RACH trigger to the unlicensed radio control unit 23. Furthermore, the unlicensed RACH processing unit 27B receives an instruction for a response to the RACH trigger from the unlicensed radio control unit 23, creates the response and transmits it via the RF unit 25B.

The data processing unit 26B extracts an unlicensed transmission request or unlicensed stop request from the electric signal inputted from the RF unit 25B and outputs the request to the unlicensed radio control unit 23. The data processing unit 26B receives a transmission instruction of a response to the unlicensed transmission request or unlicensed stop request from the unlicensed radio control unit 23, generates the response and transmits the response via the RF unit 25B.

The unlicensed radio control unit 23 periodically generates capability information at a predetermined cycle and outputs the capability information to the data processing unit 26A. The capability information is generated at an interval of one second, for example. The unlicensed radio control unit 23 stores information included in the capability information in a storage region of the memory 203.

When transmission is started at an unlicensed band frequency at which the unlicensed transmission request is received upon receiving the unlicensed transmission request from the UE 1, the unlicensed radio control unit 23 reflects an operating state of the frequency in the information included in the capability information in the memory 203. On the other hand, when transmission is stopped at an unlicensed band frequency at which the unlicensed transmission stop request is received upon receiving the unlicensed stop request from the UE 1, the unlicensed radio control unit 23 reflects the operating state of the frequency in the information included in the capability information in the memory 203.

In addition to periodically transmitting capability information, the unlicensed radio control unit 23 may also take the opportunity of an update of the information included in the capability information to transmit the capability information.

The unlicensed radio control unit 23 performs unlicensed band connection determination processing and unlicensed band connection stop processing.

The unlicensed radio control unit 23 receives an input of the RACH trigger from the unlicensed RACH processing unit 27B and performs unlicensed band connection determination processing. For example, the RACH trigger includes a base station ID of a base station to which the UE 1, the source of the RACH trigger, is connected, that is, the serving base station 2. The unlicensed radio control unit 23 determines, based on the base station ID of the base station which is included in the RACH trigger and to which the UE 1 is connected, whether the own station is a serving base station or a peripheral base station with respect to the UE 1. The data format of the RACH trigger will be described later.

When it is determined that the own station is a serving base station with respect to the UE 1 which is the source of the RACH trigger, the unlicensed radio control unit 23 determines whether or not the unlicensed band frequency is available depending on whether or not an operation procedure is currently underway for the unlicensed band frequency other than the frequency which is a target of the RACH trigger operation request. The unlicensed radio control unit 23 outputs an instruction for transmitting a response to the RACH trigger including the determination result to the unlicensed RACH processing unit 27B.

When it is determined that the own station is a peripheral base station 3 with respect to the UE 1 which is the source of the RACH trigger, the unlicensed radio control unit 23 determines whether or not the unlicensed band frequency is available depending on whether or not an operation procedure is currently underway for the unlicensed band frequency which is a target of the RACH trigger operation request. The unlicensed radio control unit 23 outputs an instruction for transmitting a response to the RACH trigger including the determination result to the unlicensed RACH processing unit 27B.

Upon receiving an input of an unlicensed transmission request from the data processing unit 26B, the unlicensed radio control unit 23 starts transmission of an RS signal at a receiving frequency of the unlicensed transmission request and starts a CA service. The unlicensed radio control unit 23 reflects an operating state of the unlicensed band frequency, transmission of which is started in the capability information.

Upon receiving the unlicensed stop request from the data processing unit 26B, the unlicensed radio control unit 23 performs unlicensed band connection stop processing. In the unlicensed band connection stop processing, the unlicensed radio control unit 23 determines whether or not to stop transmission at the frequency depending on the presence or absence of the UE 1 that uses the unlicensed band frequency which is a target of the stop request other than the UE 1 which is the source of the unlicensed stop request. When transmission stop is determined, the unlicensed radio control unit 23 stops transmission at the frequency. The unlicensed radio control unit 23 outputs an instruction for transmitting a response to the unlicensed stop request including the determination result or stop processing result to the data processing unit 26B. The unlicensed radio control unit 23 reflects an operating state of the unlicensed band frequency, transmission of which is stopped, in the capability information.

<Information which is Exchanged>

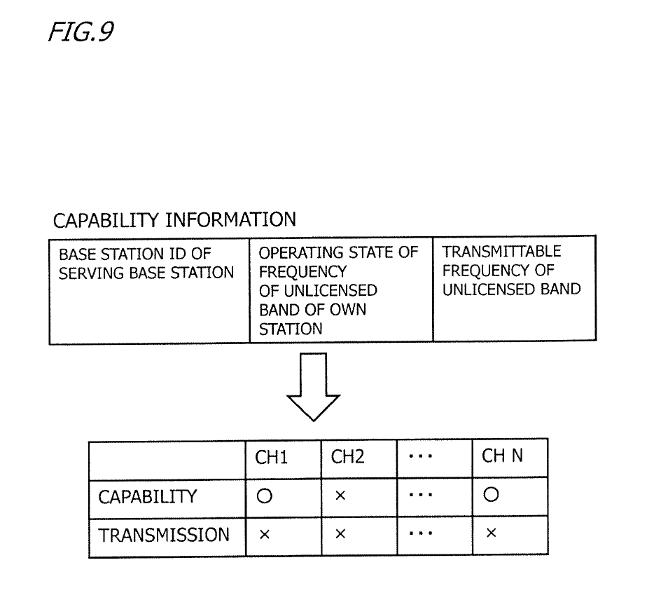

FIG. 9 is a diagram illustrating an example of information included in the capability information. The capability information includes, for example, a base station ID of the serving base station 2 as information on the source, information on transmittable frequencies in the unlicensed band and information on operating states of frequencies in the unlicensed band at the own station.

The transmittable frequencies in the unlicensed band are defined for each country and each region. For example, in Japan, use of the unlicensed band outdoors is prohibited by a ministerial ordinance, whereas use of predetermined frequencies of the unlicensed band outdoors is permitted. The UE 1 holds information on frequencies in the unlicensed band, but holds no information on which frequency is available. For this reason, the UE 1 is notified of transmittable frequencies in the unlicensed band by capability information.

For example, the information on transmittable frequencies in the unlicensed band and the information on the operating states of frequencies in the unlicensed band are stored in the capability information in a table format illustrated in FIG. 9. When the operating states (“transmission” in the table) of frequencies in the unlicensed band indicate “x” (no) for all frequencies, it is indicated that the unlicensed band is not used in the serving base station 2.

The capability information is transmitted by broadcasting from the serving base station 2 at a frequency used for current communication in the licensed band. Note that the capability information illustrated in FIG. 9 is an example and the information included in the capability information is not limited to the example illustrated in FIG. 9.

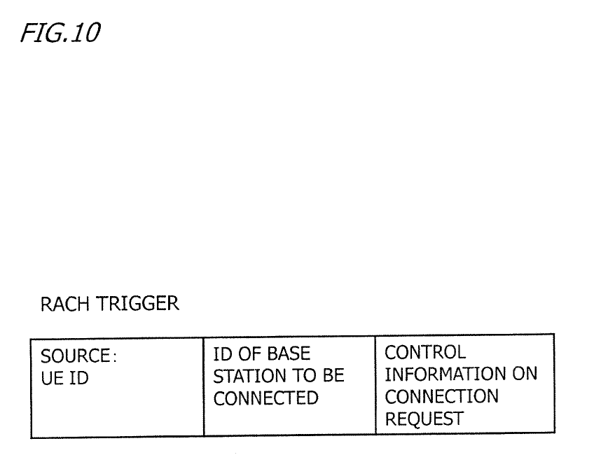

FIG. 10 is a diagram illustrating an example of information included in the RACH trigger. The RACH trigger includes, as information on the source, an ID of the UE 1, a base station ID of the base station to be connected and control information on a connection request. The RACH trigger is an example of the “operation request.”

For the ID of the UE 1, any one of IMSI (international mobile subscriber identity) and P-TMSI (packet-temporary MSI) which are identification numbers uniquely assigned to the terminal is used. The base station ID of the base station to be connected is a base station ID of the serving base station of the UE 1. The control information on the connection request includes, for example, performance information of the UE 1. The performance information of the UE 1 includes terminal information needed to be connected to the core network side as, for example, an NAS (non-access-stratum) UE identifier.

The RACH trigger is transmitted by broadcasting at the operation candidate frequency of the unlicensed band selected by the UE 1, that is, the operation request target frequency of the RACH trigger. The RACH trigger is transmitted, as in the case of a RACH signal conventionally used in the licensed band, using a time slot, frequency slot and code slot in the RACH region determined in advance between the terminal and the base station in a radio frame.

The random access channel (RACH) is an uplink (UL) transport channel used to transmit data or control information when there is no individual radio link. For example, the ID of the UE 1, base station ID of the base station to be connected and control information on a connection request included in the RACH trigger in the example illustrated in FIG. 10 are stored in the data part of the RACH message unit in the RACH region.

Note that the region in the radio frame (time slot, frequency slot, code slot) to transmit the RACH trigger need not be determined in advance between the terminal and the base station. When the RACH trigger is transmitted using the region determined in advance between the terminal and the base station, since the frequency slot or the like is determined in advance, the base station on the receiving side can estimate the operation request target frequency (center frequency of the radio frame) from the received RACH trigger.

However, when the region in the radio frame to be used to transmit the RACH trigger is not determined in advance between the terminal and the base station, the base station on the receiving side is unable to estimate the operation request target frequency from the received RACH trigger (center frequency of the radio frame). For this reason, when the region used to transmit the RACH trigger in the radio frame is not determined in advance between the terminal and the base station, the UE 1 includes information on the operation request target frequency in the RACH trigger (operation candidate frequency). Note that the information included in the RACH trigger illustrated in FIG. 10 is an example and is not limited to the example illustrated in FIG. 10.

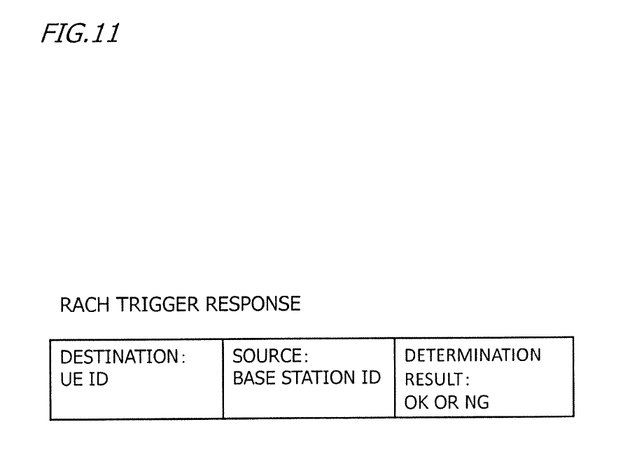

FIG. 11 is a diagram illustrating an example of information included in a RACH trigger response. The RACH trigger response includes the UE ID as information on the destination, the base station ID as information on the source and the determination result.

The determination result is a determination result of the unlicensed band connection determination processing in the base station which is the source. The determination result includes either OK or NG. A RACH trigger response, the determination result of which includes “OK” will be hereinafter referred to as an “OK response.” A RACH trigger response, the determination result of which includes “NG” will be hereinafter referred to as an “NG response.”

The RACH trigger response is transmitted by unicasting from the base station 2 to the UE 1 which is the source of the RACH trigger at an unlicensed band operation request target frequency of the RACH trigger (operation candidate frequency). Note that the information included in the RACH trigger response illustrated in FIG. 11 is an example and is not limited to the example illustrated in FIG. 11.

<Flow of Processing>

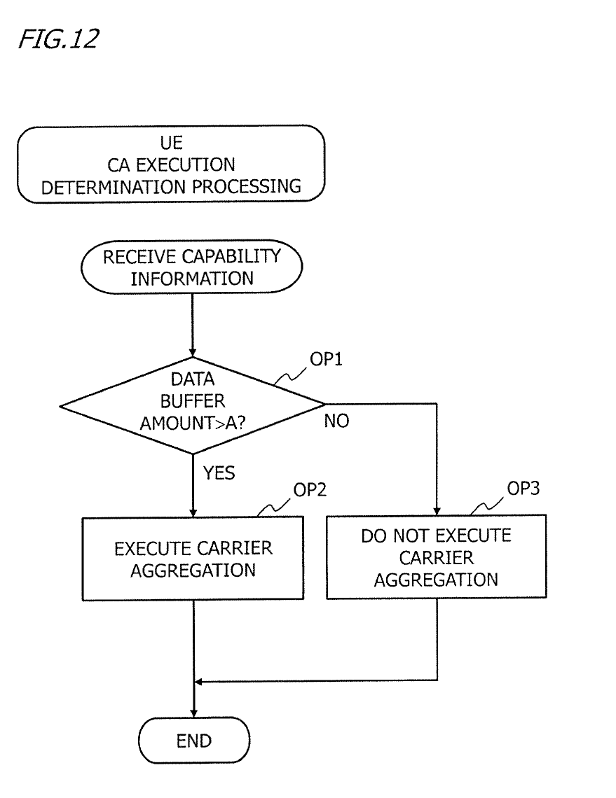

FIG. 12 is an example of a flowchart of CA execution determination processing executed by the UE 1. The CA execution determination processing is processing corresponding to “determination 1” in S12 in FIG. 4. The processing illustrated in FIG. 12 is started when the UE 1 receives capability information. Hereinafter, a flowchart of processing executed by the UE 1 will be described by considering the unlicensed radio control unit 13 as a subject, which is actually the CPU 101.

In OP1, the unlicensed radio control unit 13 determines whether or not the communication buffer amount of the data processing unit 16A is greater than a predetermined threshold A. When the communication buffer amount of the data processing unit 16A is greater than the predetermined threshold A (OP1: YES), the process proceeds to OP2. When the communication buffer amount of the data processing unit 16A is equal to or smaller than the predetermined threshold A (OP1: NO), the process proceeds to OP3.

In OP2, since the communication buffer amount of the data processing unit 16A is greater than the predetermined threshold A, the unlicensed radio control unit 13 determines execution of CA using the unlicensed band. After that, the processing illustrated in FIG. 12 ends.

In OP3, since the communication buffer amount of the data processing unit 16A is equal to or smaller than the predetermined threshold A, the unlicensed radio control unit 13 determines not to execute CA using the unlicensed band.

Note that when the CA execution determination processing is performed not based on the communication buffer amount of the data processing unit 16A but based on the type of a communication application, the unlicensed radio control unit 13 in OP1 determines whether or not the communication application type is a predetermined application type. When the communication application type is a predetermined application type, the process proceeds to OP2. When the communication application type is not the predetermined application type, the process proceeds to OP3.

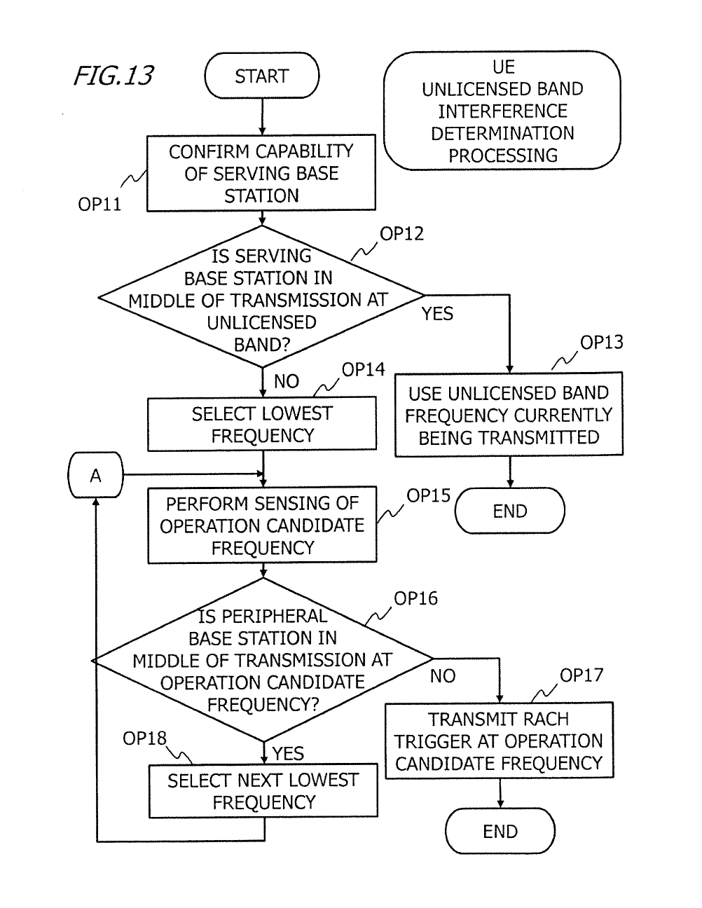

FIG. 13 is an example of a flowchart of unlicensed band interference determination processing executed by the UE 1. The unlicensed band interference determination processing is processing corresponding to “process 1” in S13 in FIG. 4. The processing illustrated in FIG. 13 is started when execution of CA using the unlicensed band is determined by the CA execution determination processing.

In OP11, the unlicensed radio control unit 13 confirms the capability information of the serving base station 2. Next, the process proceeds to OP12.

In OP12, the unlicensed radio control unit 13 determines whether or not the serving base station 2 is transmitting an RS signal at any one frequency of the unlicensed band. In the case of the capability information illustrated in FIG. 9, for example, this determination is made by determining whether or not all the items of “transmission” of the unlicensed band frequency indicate “x” (no). When the serving base station 2 is transmitting an RS signal at any one frequency of the unlicensed band (OP12: YES), the process proceeds to OP13. When the serving base station 2 is not transmitting the RS signal at any unlicensed band frequency (OP12: NO), the process proceeds to OP14.

In OP13, since the serving base station 2 is transmitting the RS signal at any one frequency of the unlicensed band, the unlicensed radio control unit 13 determines to use the unlicensed band frequency being currently transmitted. After that, the processing illustrated in FIG. 13 ends. When the unlicensed band frequency being currently transmitted is used, the presence or absence of interference need not be determined, and therefore the licensed radio control unit 13 starts CA.

Processes in and after OP14 are processes that select an operation candidate frequency in the unlicensed band used for CA when the serving base station 2 is not transmitting an RS signal at any unlicensed band frequency.

In OP14, the unlicensed radio control unit 13 selects a lowest frequency as the operation candidate frequency from among frequencies in the unlicensed band at which transmission with the capability information is considered possible. Next, the process proceeds to OP15.

In OP15, the unlicensed radio control unit 13 senses the operation candidate frequency. Sensing of an unlicensed band channel is performed by the data processing unit 16B and the unlicensed radio control unit 13 receives the sensing result. When base stations transmitting radio waves at the operation candidate frequency are located in the periphery of the UE 1, the received radio waves are detected by sensing at the operation candidate frequency. When no base station transmitting a radio wave at the operation candidate frequency is located in the periphery of the UE 1, no received radio wave is detected at the operation candidate frequency for a predetermined period during which sensing is performed. Next, the process proceeds to OP16.

In OP16, the unlicensed radio control unit 13 determines whether or not the peripheral base station 3 is performing transmission at the operation candidate frequency. This determination is made based on the sensing result in OP15. When the peripheral base station 3 performing transmission at the operation candidate frequency exists (OP16: YES), the process proceeds to OP18. When no peripheral base station 3 performing transmission at the operation candidate frequency exists (OP16: NO), the process proceeds to OP17.

In OP17, since no peripheral base station 3 performing transmission at the operation candidate frequency exists, the unlicensed radio control unit 13 instructs the unlicensed RACH processing unit 17B to transmit a RACH trigger at the operation candidate frequency. After that, the RACH trigger is transmitted from the unlicensed RACH processing unit 17B. After that, the processing illustrated in FIG. 13 ends.

In OP18, since the peripheral base station 3 performing transmission at the operation candidate frequency exists and interference occurs if transmission is performed at the operation candidate frequency, the unlicensed radio control unit 13 newly selects a frequency next lowest to the current operation candidate frequency from among transmittable frequencies in the unlicensed band as the operation candidate frequency. Subsequently, processes from OP15 onward are repeated for new operation candidate frequencies.

Note that in the example illustrated in FIG. 13, the lowest frequency is selected first as the operation candidate frequency from among available frequencies in the unlicensed band, but without being limited to this, for example, a highest frequency may be selected first or frequencies may be selected randomly.

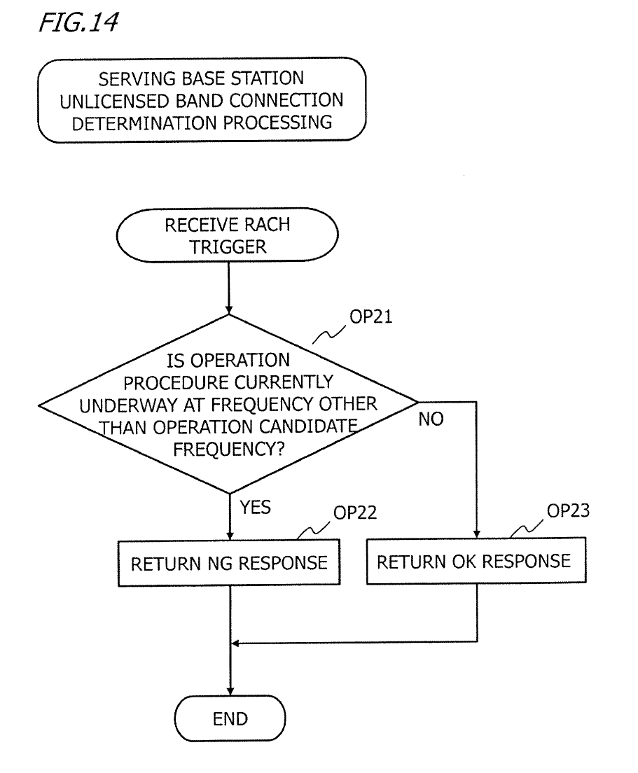

FIG. 14 is an example of a flowchart of unlicensed band connection determination processing executed by the serving base station 2. The unlicensed band connection determination processing corresponds to the processing of “determination 2” in S15 in FIG. 4. The processing illustrated in FIG. 14 is started when the serving base station 2 receives a RACH trigger from the UE 1. Hereinafter, a flowchart of processing executed by the base station 2 will be described by considering the unlicensed radio control unit 23 as a subject, which is actually the CPU 201. Note that whether the own station is a serving base station or a peripheral base station with respect to the UE 1 which is the source of the RACH trigger is determined by referencing the base station ID of the base station to be connected, included in the RACH trigger (see FIG. 10).

In OP21, the unlicensed radio control unit 23 determines whether or not an operation procedure is currently underway for an operation request target frequency in the RACH trigger, that is, a frequency other than the operation candidate frequency. The RACH trigger is transmitted at the operation candidate frequency selected by the unlicensed band interference determination processing of the UE 1 (see FIG. 13). Therefore, the operation candidate frequency is acquired from the receiving frequency of the RACH trigger. Alternatively, when the RACH trigger includes information on the operation candidate frequency, the operation candidate frequency is acquired from the information included in the RACH trigger.

When the operation procedure is currently underway for an unlicensed band frequency other than the operation candidate frequency (OP21: YES), the process proceeds to OP22. When an operation procedure is not currently underway for an unlicensed band frequency other than the operation candidate frequency (OP21: NO), the process proceeds to OP23.

In OP22, since the operation procedure is currently underway for the unlicensed band frequency other than the operation candidate frequency, the unlicensed radio control unit 23 determines rejection of use in response to an operation request for the operation candidate frequency. This is because upon receiving another RACH trigger while processing one RACH trigger, for example, the unlicensed radio control unit 23 gives priority to processing on the RACH trigger received earlier and does not process the RACH trigger received later.

The unlicensed radio control unit 23 instructs the unlicensed RACH processing unit 27B to transmit a RACH trigger response which is an NG response. After that, the unlicensed RACH processing unit 27B transmits a RACH trigger response and the processing illustrated in FIG. 14 ends.

In OP23, since an operation procedure is not currently underway for unlicensed band frequencies other than the operation candidate frequency, the unlicensed radio control unit 23 determines permission for operation in response to an operation request for the operation candidate frequency. The unlicensed radio control unit 23 instructs the unlicensed RACH processing unit 27B to transmit a RACH trigger response which is an OK response. After that, the unlicensed RACH processing unit 27B transmits a RACH trigger response and the processing illustrated in FIG. 14 ends.

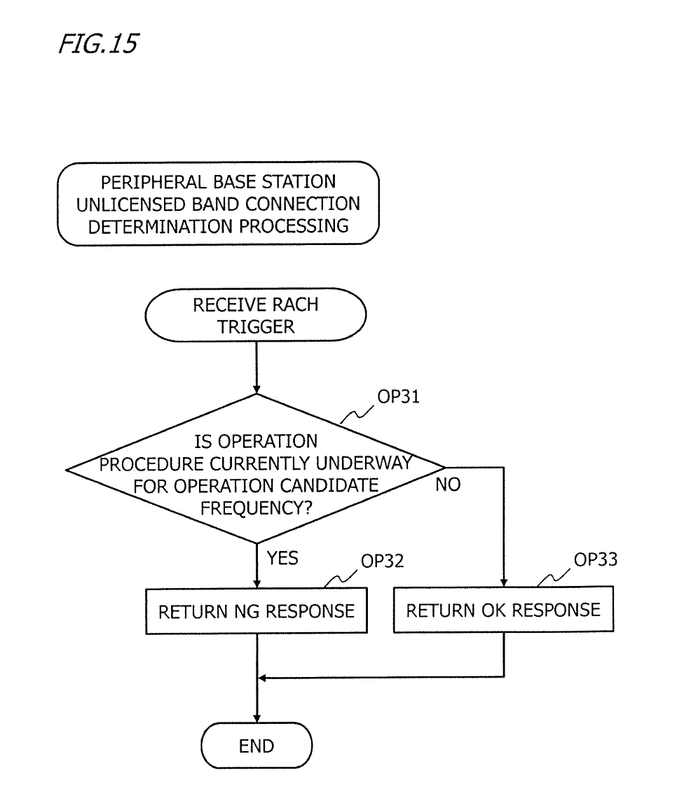

FIG. 15 is an example of a flowchart of unlicensed band connection determination processing executed by the peripheral base station 3. The unlicensed band connection determination processing illustrated in FIG. 15 corresponds to the processing of “determination 3” in S16 in FIG. 4. The processing illustrated in FIG. 15 is started when the base station receives a RACH trigger and determines that a base station ID of the base station to be connected included in the RACH trigger does not belong to the own station and the own station is a peripheral base station with respect to the UE 1 which is the source of the RACH trigger.

In OP31, the unlicensed radio control unit 23 determines whether or not an operation procedure is currently underway for the unlicensed band operation request target frequency of the RACH trigger, that is, the operation candidate frequency. When the operation procedure is currently underway for the operation candidate frequency (OP31: YES), the process proceeds to OP32. When the operation procedure is not currently underway for the operation candidate frequency (OP31: NO), the process proceeds to OP33.

In OP32, since the operation procedure is currently underway for the operation candidate frequency, the unlicensed radio control unit 23 determines that the operation candidate frequency is “unusable” in response to an operation request for the operation candidate frequency and instructs the unlicensed RACH processing unit 27B to transmit a RACH trigger response which is an NG response. After that, the unlicensed RACH processing unit 27B transmits the RACH trigger response and the processing illustrated in FIG. 15 ends.

In OP33, since the operation procedure is not currently underway for the operation candidate frequency, the unlicensed radio control unit 23 determines permission for operation in response to the operation request for the operation candidate frequency and instructs the unlicensed RACH processing unit 27B to transmit a RACH trigger response which is an OK response. After that, the unlicensed RACH processing unit 27B transmits the RACH trigger response and the processing illustrated in FIG. 15 ends.

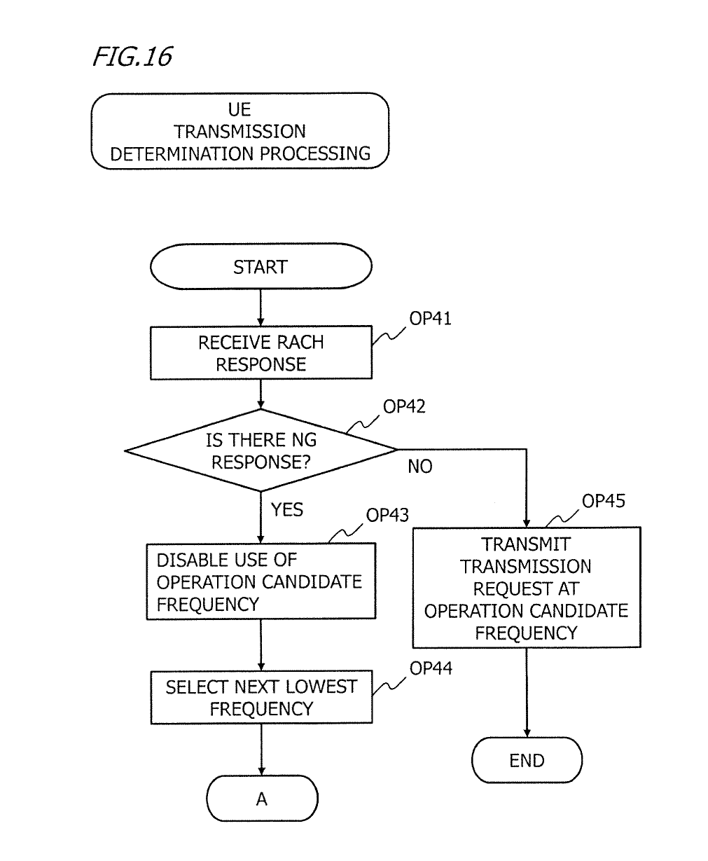

FIG. 16 is an example of a flowchart of transmission determination processing executed by the UE 1. The transmission determination processing is processing corresponding to “determination 4” in S18 in FIG. 4. The processing illustrated in FIG. 16 is started when the UE 1 receives a RACH trigger response.

In OP41, the unlicensed radio control unit 13 receives the RACH trigger response until a predetermined time elapses after the process starts. The predetermined time is, for example, a time period until the next random access occurs. When the peripheral base station 3 exists in addition to the serving base station 2, the UE 1 receives at least two RACH trigger responses. Next, the process proceeds to OP42.

In OP42, the unlicensed radio control unit 13 determines whether or not the received RACH trigger response includes an NG response. When the received RACH trigger response includes an NG response (OP42: YES), the process proceeds to OP43. When all the received RACH trigger responses are OK responses (OP42: NO), the process proceeds to OP45.

In OP43, since some of the received RACH trigger responses include NG responses, the unlicensed radio control unit 13 determines that the operation candidate frequency is “unusable.” Next, the process proceeds to OP44.

In OP44, the unlicensed radio control unit 13 selects a frequency next lowest to the current operation candidate frequency from among transmittable frequencies in the unlicensed band as a new operation candidate frequency. Next, the process proceeds to OP15 in FIG. 13 and processing on the new operation candidate frequency starts from the unlicensed band interference determination processing.

In OP45, since all the received RACH trigger responses are OK responses, it is indicated that no interference occurs with the operation candidate frequency, and so the unlicensed radio control unit 23 instructs the data processing unit 16B to transmit an unlicensed transmission request to the serving base station 2 at the operation candidate frequency. After that, the data processing unit 16B transmits an unlicensed transmission request and the processing illustrated in FIG. 16 ends.

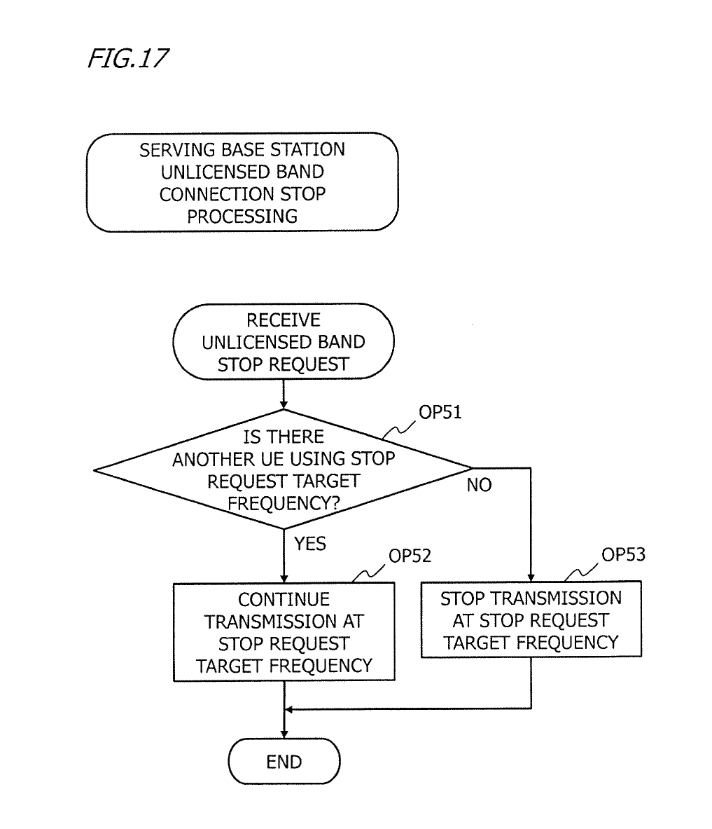

FIG. 17 is an example of a flowchart of unlicensed band connection stop processing executed by the serving base station 2. The unlicensed band connection stop processing is processing corresponding to “determination 5” in S22 in FIG. 4. The processing illustrated in FIG. 17 is started when the serving base station 2 receives an unlicensed stop request from the UE 1.

In OP51, the unlicensed radio control unit 23 determines the presence or absence of another UE 1 using an unlicensed band frequency which is a stop request target. The unlicensed band frequency which is a stop request target is acquired from the receiving frequency of the unlicensed stop request.

When another UE 1 using the unlicensed band frequency which is a stop request target exists (OP51: YES), the process proceeds to OP52. When no UE 1 using the unlicensed band frequency which is a stop request target exists (OP51: NO), the process proceeds to OP53.

In OP52, since the other UE 1 using the unlicensed band frequency which is a stop request target exists, the unlicensed radio control unit 23 continues transmission at the unlicensed band frequency. After that, the processing illustrated in FIG. 17 ends.

In OP53, since no other UE 1 using the unlicensed band frequency which is a stop request target exists, the unlicensed radio control unit 23 determines stoppage of transmission of the unlicensed band frequency and instructs the data processing unit 26B to stop transmission and transmit a response to the stop request. After that, the processing illustrated in FIG. 17 ends.

### Operations and Effects of First Embodiment

In the first embodiment, the serving base station 2 notifies the UE 1 of information on transmittable frequencies in the unlicensed band of the own station and information on operating states of frequencies in the unlicensed band using capability information. The UE 1 selects an operation candidate frequency from among frequencies currently not in use in the unlicensed band based on the capability information. Even when the serving base station 2 and the peripheral base station 3 are located out of the reach of their respective radio waves and the cell of the serving base station 2 overlaps the cell of the peripheral base station 3, it is possible to avoid radio wave interference of the unlicensed band.

For example, when the UE 1 performs sensing, although use of the operation candidate frequency by the peripheral base station 3 is not detected, the peripheral base station 3 may receive a transmission request from the other UE 1 at the frequency and perform a procedure to use the frequency until the UE 1 transmits the transmission request to the serving base station 2 at the operation candidate frequency. In this case, radio wave interference occurs at the operation candidate frequency of the unlicensed band. In the first embodiment, the UE 1 makes an operation request to each base station at the operation candidate frequency of the unlicensed band using a RACH trigger. When an operation procedure by the peripheral base station 3 is currently underway for the operation candidate frequency, a determination result on the operation request becomes NG and the operation candidate frequency is not used. This makes it possible to avoid interference of the unlicensed band.

In the first embodiment, when a communication service ends, the UE 1 transmits an unlicensed stop request, and the serving base station 2 confirms whether or not the unlicensed band frequency which is a stop request target used by the other UE 1 after receiving the stop request, and then stops transmission of the frequency. This makes it possible to avoid influences caused by the end of communication at the unlicensed band frequency by the UE 1 on communication at the frequency in the unlicensed band of the other UE 1.

### Second Embodiment

In a second embodiment, not the UE 1 but the serving base station 2 determines execution of CA. Description of the second embodiment that overlaps that of the first embodiment will be omitted.

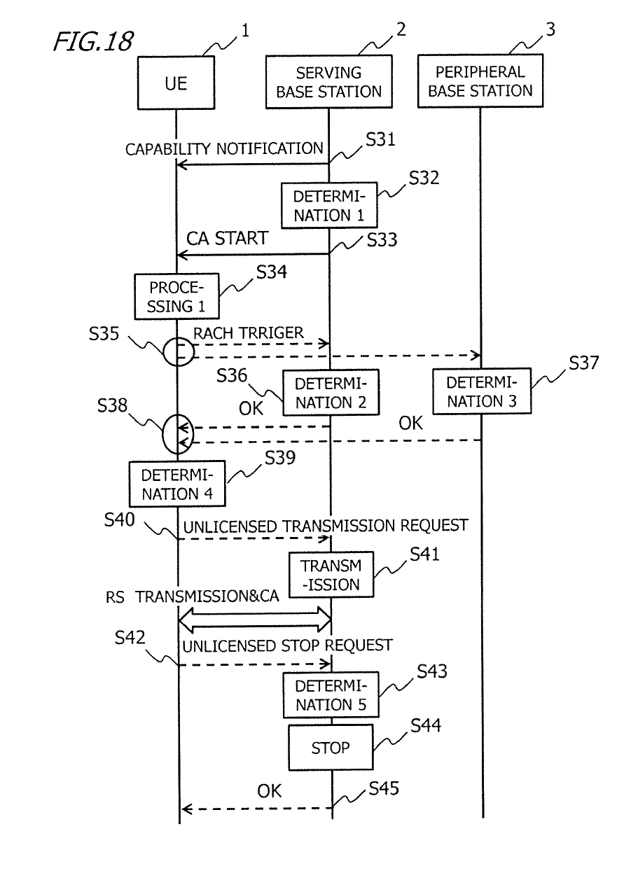

FIG. 18 is a diagram illustrating an example of a processing sequence by the radio communication system 100 according to the second embodiment. The configuration of the radio communication system 100 according to the second embodiment is similar to that according to the first embodiment. The hardware configuration and the software configuration of the UE 1 and the base station 2 are also similar to those in the first embodiment. As a premise, suppose communication at a predetermined frequency of a licensed band is currently underway between the UE 1 and the serving base station 2.

In S31, the serving base station 2 periodically notifies the UE 1 of capability information through broadcast transmission at the licensed band frequency used for communication with the UE 1.

In S32, the serving base station 2 takes the opportunity of transmission of capability information to perform CA execution determination processing (determination 1) of determining whether or not to perform CA execution using the unlicensed band frequency. The CA execution determination processing by the serving base station 2 is also performed based on the amount of data stored in a communication buffer and application attributes used for communication as in the case of the CA execution determination processing by the UE 1 of the first embodiment.

In S33, when CA execution using an unlicensed band frequency is determined in the CA execution determination processing, the serving base station 2 transmits an instruction for starting CA to the UE 1. Processes in and after S34 onward are similar to the processes in and after S13 in FIG. 4 of the first embodiment.

In the second embodiment, the unlicensed radio management unit 24 of the base station 2 monitors a communication buffer amount of the data processing unit 26A, that is, a processing load of communication at a licensed band frequency. Furthermore, upon receiving a read instruction from the unlicensed radio control unit 23, the unlicensed radio management unit 24 outputs the communication buffer amount of the data processing unit 26A to the unlicensed radio control unit 23.

Upon receiving a notice of transmission of capability information from the data processing unit 26A, the unlicensed radio control unit 23 starts CA execution determination processing. In the CA execution determination processing, the unlicensed radio control unit 23 acquires the communication buffer amount of the data processing unit 26A from the unlicensed radio management unit 24 and determines whether or not to execute CA using the unlicensed band frequency depending on whether or not the communication buffer amount is greater than a predetermined threshold.

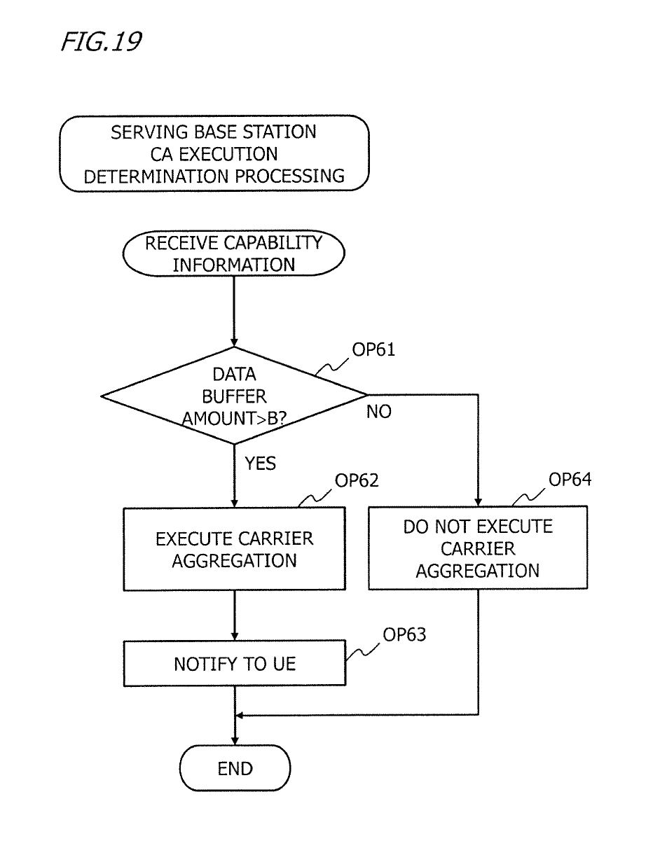

FIG. 19 is an example of a flowchart of the CA execution determination processing executed by the serving base station 2. The CA execution determination processing corresponds to the processing of “determination 1” in S32 in FIG. 18. The processing illustrated in FIG. 19 is started when the serving base station 2 transmits capability information.

In OP61, the unlicensed radio control unit 23 determines whether or not the communication buffer amount of the data processing unit 26A is greater than a predetermined threshold B. When the communication buffer amount of the data processing unit 26A is greater than the predetermined threshold B (OP61: YES), the process proceeds to OP62. When the communication buffer amount of the data processing unit 26A is equal to or smaller than the predetermined threshold B (OP61: NO), the process proceeds to OP64.

In OP62, since the communication buffer amount of the data processing unit 26A is greater than the predetermined threshold B, the unlicensed radio control unit 23 determines execution of CA using the unlicensed band frequency. Next, the process proceeds to OP63.

In OP63, the unlicensed radio control unit 23 instructs the data processing unit 26A to notify the UE 1 of CA execution using the unlicensed band frequency. Then, the data processing unit 26A transmits a notice of CA execution using the unlicensed band frequency to the UE 1 and the processing illustrated in FIG. 19 ends. Upon receiving the notice of CA execution, the UE 1 starts unlicensed band interference determination processing.

In OP64, since the communication buffer amount of the data processing unit 26A is equal to or smaller than the predetermined threshold B, the unlicensed radio control unit 23 determines no execution of CA using the unlicensed band frequency. After that, the processing illustrated in FIG. 19 ends.

According to the second embodiment, it is possible to execute CA using the unlicensed band triggered by the serving base station 2 in accordance with the processing load associated with communication at the licensed band frequency of the serving base station 2. Note that the first embodiment may be combined with the second embodiment. That is, the UE 1 and the serving base station 2 may respectively determine execution of CA using the unlicensed band frequency and trigger the starting of CA using the unlicensed band frequency.

### Third Embodiment

In a third embodiment, when executing CA using the unlicensed band frequency, the UE 1 notifies the peripheral base station 3 of transmission disabling or cancellation of transmission disabling at the unlicensed band frequency used by CA. Description of the third embodiment that overlaps that of the first embodiment will be omitted.

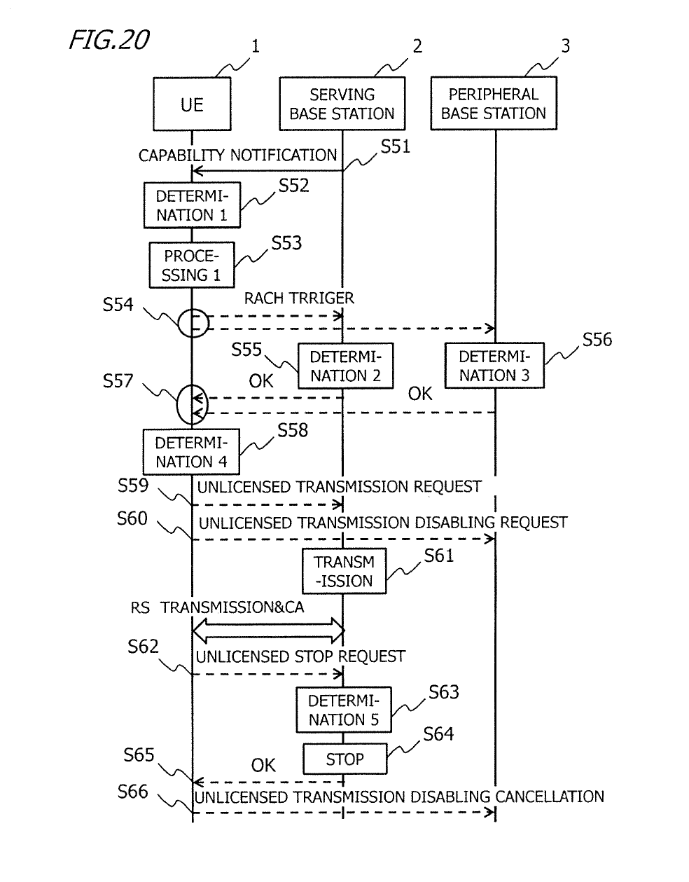

FIG. 20 is a diagram illustrating an example of a processing sequence in the radio communication system 100 according to the third embodiment. The configuration of the radio communication system 100 in the third embodiment is similar to that of the first embodiment as well. Furthermore, the hardware configuration and the software configuration of the UE 1 and the base station 2 are also similar to those in the first embodiment. As a premise, suppose that communication is currently underway between the UE 1 and the serving base station 2 at a predetermined frequency of a licensed band.

Processes in S51 to S58 are similar to the processes in S11 to S18 in FIG. 4 in the first embodiment.

In S59, when determining transmission of a transmission request at the unlicensed band operation candidate frequency selected in the transmission determination processing (determination 4), the UE 1 transmits the transmission request to the serving base station 2.

In S60, the UE 1 transmits an unlicensed transmission disabling request to the peripheral base station 3 at the unlicensed band operation candidate frequency selected in the transmission determination processing (determination 4). Upon receiving the unlicensed transmission disabling request, the peripheral base station 3 will no longer perform transmission at the operation candidate frequency of the unlicensed band hereinafter until the peripheral base station 3 receives a notice of unlicensed transmission disabling cancellation at the operation candidate frequency of the unlicensed band from the UE 1.

Hereinafter, processes in S61 to S65 are similar to the transmission processing of the unlicensed band by the serving base station 2 in S20 to S24 in FIG. 4 of the first embodiment and the unlicensed band connection stop processing by the UE 1 and the serving base station 2.

In S66, upon receiving an OK response to the unlicensed stop request from the serving base station 2, the UE 1 transmits unlicensed transmission disabling cancellation to the peripheral base station 3 at the frequency which is a stop request target.

The notices of the unlicensed transmission disabling request and the cancellation are generated under an instruction of the unlicensed radio control unit 13 of the UE 1 by the unlicensed RACH processing unit 17B of the UE 1 and transmitted at a frequency which is a transmission disabling request target in the unlicensed band.

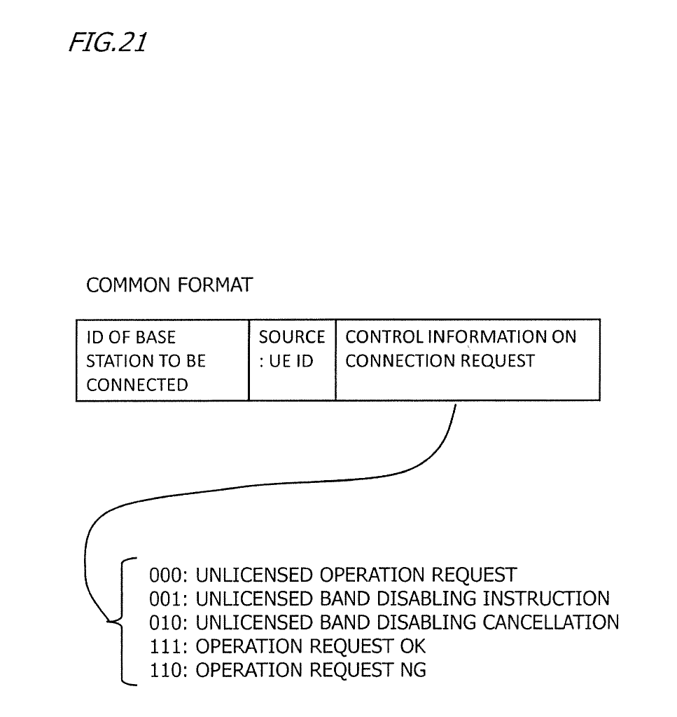

FIG. 21 is a diagram illustrating an example of a format of an unlicensed transmission disabling request according to the third embodiment. In the third embodiment, a common format is used for a RACH trigger, RACH trigger response, unlicensed transmission disabling request and unlicensed transmission disabling cancellation. The common format includes a base station ID of a base station to be connected, a UE ID as information on a source and control information on a connection request.

Since the common format is used for the RACH trigger, RACH trigger response, unlicensed transmission disabling request and unlicensed transmission disabling cancellation, the control information on the connection request includes a code indicating a message type.

For example, the message type code corresponds to leading 3 bits of the control information on the connection request and is set as follows. A message type code “000” indicates an unlicensed operation request (RACH trigger). A message type code “001” indicates an unlicensed transmission disabling request. A message type code “010” indicates an unlicensed transmission disabling cancellation. A message type code “111” indicates an unlicensed operation request response (OK). A message type code “110” indicates an unlicensed operation request response (NG). However, the settings of these message type codes are not limited to this.

The RACH trigger, unlicensed transmission disabling request or unlicensed transmission disabling cancellation is transmitted by broadcasting at an unlicensed band operation candidate frequency selected by the UE 1. The RACH trigger, unlicensed transmission disabling request or unlicensed transmission disabling cancellation is transmitted through a time slot, a frequency slot or a code slot in a RACH region in a radio frame determined in advance between the terminal and the base station. Note that the region in the radio frame used for transmission of the RACH trigger, unlicensed transmission disabling request or unlicensed transmission disabling cancellation need not be determined in advance. In this case, the control information on a connection request includes information on the target frequency.

The base station 2 that receives the unlicensed transmission disabling request or unlicensed transmission disabling cancellation sets, when the base station ID of the base station to be connected does not correspond to the own station, that is, the own station is a peripheral base station, a channel which is an unlicensed band transmission disabling target to be “transmission disabled” or “transmission enabled.” When the base station ID of the base station to be connected corresponds to the own station, that is, when the own station is a serving base station, the serving base station 2 discards the unlicensed transmission disabling request or unlicensed transmission disabling cancellation.

In the third embodiment, the UE 1 notifies an unlicensed band transmission disabling request or transmission disabling cancellation used by CA, and can thereby prevent the peripheral base station 3 from performing transmission at an unlicensed band frequency used by CA while the UE 1 is executing CA.

### Fourth Embodiment

According to a fourth embodiment, when an unlicensed transmission disabling request or unlicensed transmission disabling cancellation is received, each base station 2 reflects a target frequency of the unlicensed transmission disabling request or unlicensed transmission disabling cancellation in capability information. Description of the fourth embodiment that overlaps that of the third embodiment will be omitted.

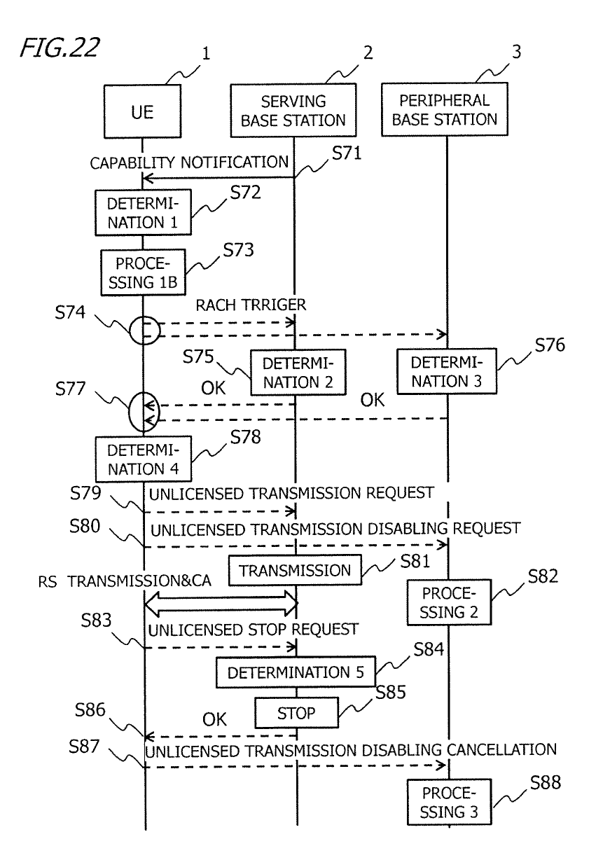

FIG. 22 is a diagram illustrating an example of a processing sequence in the radio communication system 100 according to the fourth embodiment. The configuration of the radio communication system 100 in the fourth embodiment is similar to that of the first embodiment. Furthermore, the hardware configuration and the software configuration of the UE 1 and the base station 2 are also similar to those of the first embodiment. As a premise, suppose that communication is in progress between the UE 1 and the serving base station 2 at a predetermined frequency of a licensed band.

In S71, the serving base station 2 periodically transmits capability information. In the fourth embodiment, the capability information includes information on operating states of frequencies in an unlicensed band of another base station in addition to information on transmittable frequencies in the unlicensed band and information on operating states of frequencies in the unlicensed band of the own station.

In S72, as in the case of S52 in FIG. 20 in the third embodiment, the UE1 receives capability information, performs CA execution determination processing (determination 1) and determines execution of CA using the unlicensed band frequency.

In S73, the UE 1 performs unlicensed band interference determination processing (processing 1B) and selects an unlicensed band operation candidate frequency. The unlicensed band interference determination processing of the fourth embodiment is performed based on the capability information including information on operating states of frequencies in the unlicensed band of the other base station. Details of the unlicensed band interference determination processing will be described later.

In S74 to S79, as in the case of S54 to S59 in FIG. 20 of the third embodiment, the UE 1 transmits a RACH trigger, the serving base station 2 and the peripheral base station 3 perform unlicensed band connection determination processing (determination 2, determination 3) and return a RACH trigger response. The UE 1 performs transmission determination processing (determination 4) based on the RACH trigger response and transmits a transmission request to the serving base station 2 at an unlicensed band operation candidate frequency.

In S80, as in the case of S60 in FIG. 20 of the third embodiment, the UE 1 transmits an unlicensed transmission disabling request for an unlicensed band frequency which is an unlicensed transmission request target. In S81, the serving base station 2 receives a transmission disabling request and starts transmission for the unlicensed band frequency.

In S82, the peripheral base station 3 receives the unlicensed transmission disabling request and reflects information indicating that another base station is transmitting a target channel of the unlicensed transmission disabling request in the capability information (processing 2). When the peripheral base station 3 operates for another UE 1 as the serving base station 2, the other UE 1 is notified of the capability information including information that the target channel of the unlicensed transmission disabling request is being transmitted by the other base station. When the other UE 1 performs communication using the unlicensed band, the target frequency of the unlicensed transmission disabling request is removed from operation candidates based on the capability information, which can facilitate a selection of an unlicensed band operation candidate frequency.

In S83 to S86, as in the case of S62 to S65 in FIG. 20 of the third embodiment, the UE 1 transmits an unlicensed stop request and the serving base station 2 stops transmission for the unlicensed band frequency which is a stop request target and returns a response.

In S87, the UE 1 receives an OK response of the unlicensed stop request from the serving base station 2 and transmits an unlicensed transmission disabling cancellation.

In S88, the peripheral base station 3 receives the unlicensed transmission disabling cancellation and reflects in the capability information, the fact that no base station is performing transmission about a target frequency of the unlicensed transmission disabling request at which the fact that the other base station is performing transmission is recorded in S82 (processing 3).

In the fourth embodiment, the unlicensed RACH processing unit 27B of the peripheral base station 3 extracts the unlicensed transmission disabling request and the cancellation from an electric signal and outputs them to the unlicensed radio control unit 23. Upon receiving an input of the unlicensed transmission disabling request or cancellation, the unlicensed radio control unit 23 of the peripheral base station 3 updates the capability information as in S82 and S88 in FIG. 22 when the base station ID of the base station to be connected in the unlicensed transmission disabling request or cancellation does not correspond to the ID of the own station.

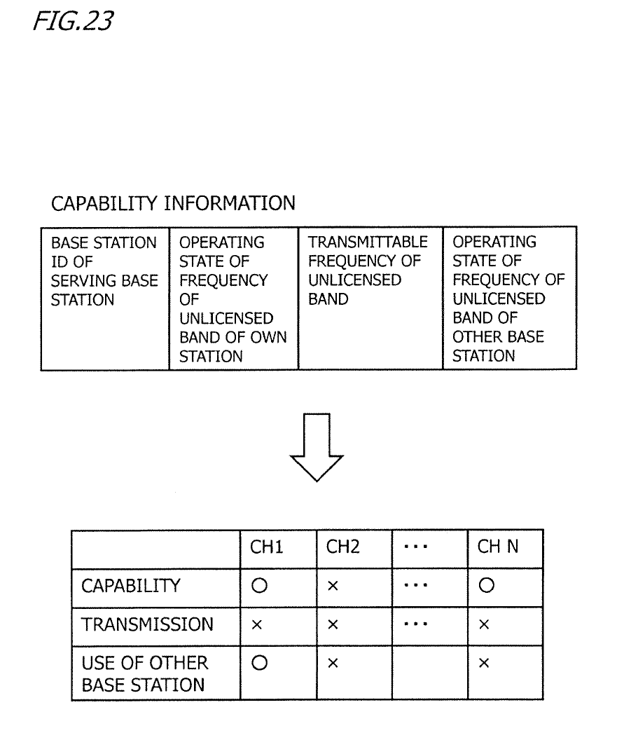

FIG. 23 is a diagram illustrating an example of information included in the capability information according to the fourth embodiment. In the fourth embodiment, the capability information includes information on operating states of frequencies in the unlicensed band of the other base station in addition to the base station ID of the serving base station 2, information on operating states of frequencies in the unlicensed band of the own station and information on transmittable frequencies in the unlicensed band as information on the source.

For example, information on the operating states of frequencies in the unlicensed band of the own station, information on transmittable frequencies in the unlicensed band, and information on operating states of frequencies in the unlicensed band of the other base station are stored in the capability information in the table format illustrated in FIG. 23. The unlicensed radio control unit 23 selects an operation candidate frequency from among frequencies marked “∘” about all the information on the operating states of frequencies in the unlicensed band of the own station, information on transmittable frequencies in the unlicensed band, and information on operating states of frequencies in the unlicensed band of the other base station.

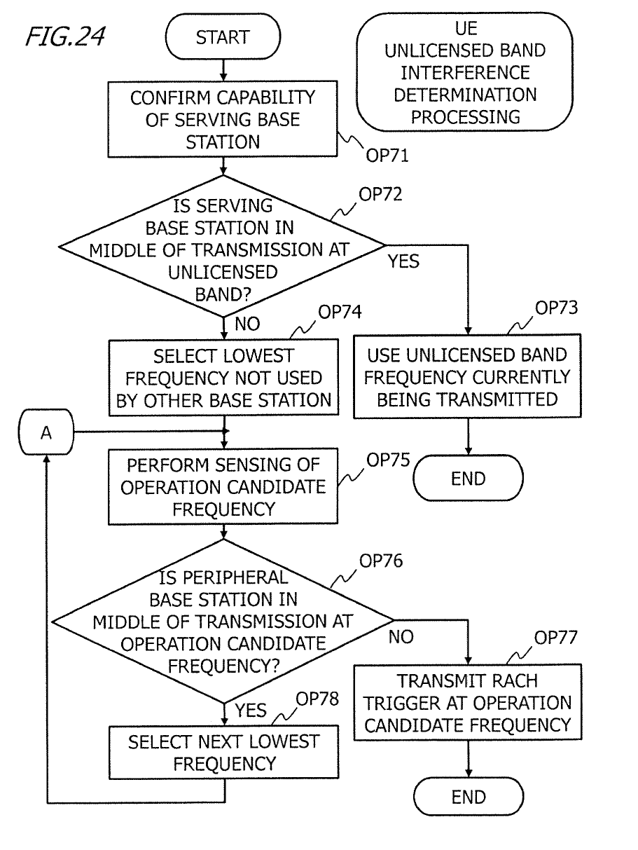

FIG. 24 is an example of a flowchart of unlicensed band interference determination processing executed by the UE 1 according to the fourth embodiment. The unlicensed band interference determination processing illustrated in FIG. 24 corresponds to the processing of “process 1B” in S73 in FIG. 22. The processing illustrated in FIG. 24 is started when execution of CA using the unlicensed band frequency is determined by the CA execution determination processing.

In OP71, the unlicensed radio control unit 13 confirms capability information of the serving base station 2. Next, the process proceeds to OP72.

In OP72, the unlicensed radio control unit 13 determines whether or not the serving base station 2 is transmitting an RS signal at any one frequency in the unlicensed band. When the serving base station 2 is transmitting an RS signal at any one frequency in the unlicensed band (OP72: YES), the process proceeds to OP73. When the serving base station 2 is not transmitting any RS signal at any one frequency in the unlicensed band (OP72: NO), the process proceeds to OP74.

In OP73, since the serving base station 2 is transmitting an RS signal at any one frequency in the unlicensed band, the unlicensed radio control unit 13 determines the use of an unlicensed band frequency currently being transmitted. After that, the processing illustrated in FIG. 24 ends. When the unlicensed band frequency currently being transmitted is used, the presence or absence of interference need not be determined, and therefore the licensed radio control unit 13 starts CA.

Since the serving base station 2 is not transmitting any RS signal at any frequency in the unlicensed band, processes in and after OP74 are processes to select an operation candidate frequency in the unlicensed band to execute CA using the unlicensed band frequency.

In OP74, the unlicensed radio control unit 13 selects, a lowest frequency from among unlicensed band frequencies which are transmittable and not currently being transmitted by other base stations as the operation candidate frequency. More specifically, the unlicensed radio control unit 13 selects as the operation candidate frequency, a lowest frequency from among frequencies marked “∘” about the information on operating states of frequencies in the unlicensed band of the own station, information on transmittable frequencies in the unlicensed band and information on operating states of frequencies in the unlicensed band of the other base stations in the capability information. Next, the process proceeds to OP75.

Processes in OP75 to OP78 are similar to the processes in OP15 to OP18 in FIG. 13 which correspond to the unlicensed band interference determination processing according to the first embodiment. The unlicensed radio control unit 13 performs sensing of the operation candidate frequency, determines the use or no use by the peripheral base station 3 and transmits, when there is no use by the peripheral base station 3, a RACH trigger at the operation candidate frequency.

In the fourth embodiment, upon receiving an unlicensed transmission disabling request and cancellation, the peripheral base station 3 reflects information on the unlicensed band frequency which is a transmission disabling request target in the capability information. The capability information includes information on operating states of frequencies in the unlicensed band of the other base station. This allows the UE 1 to acquire information on operating states of frequencies in the unlicensed band of the peripheral base station 3 which is the other base station from the capability information and remove the frequency currently being transmitted of the peripheral base station 3 from the operation candidate frequency selection targets in advance. Therefore, according to the fourth embodiment, it is possible to facilitate a selection of an unlicensed band frequency used for CA.

### Fifth Embodiment

The first to fourth embodiments have described the method for avoiding interference of the unlicensed band when the UE 1 uses the unlicensed band in CA. A fifth embodiment will describe a method for avoiding interference of the unlicensed band when the UE 1 shifts a frequency from communication of the licensed band to communication of the unlicensed band. Description of the fifth embodiment that overlaps that of the first embodiment will be omitted.

In the fifth embodiment, upon receiving an OK response of a RACH trigger, the UE 1 makes a frequency shift from a licensed band to an unlicensed band.

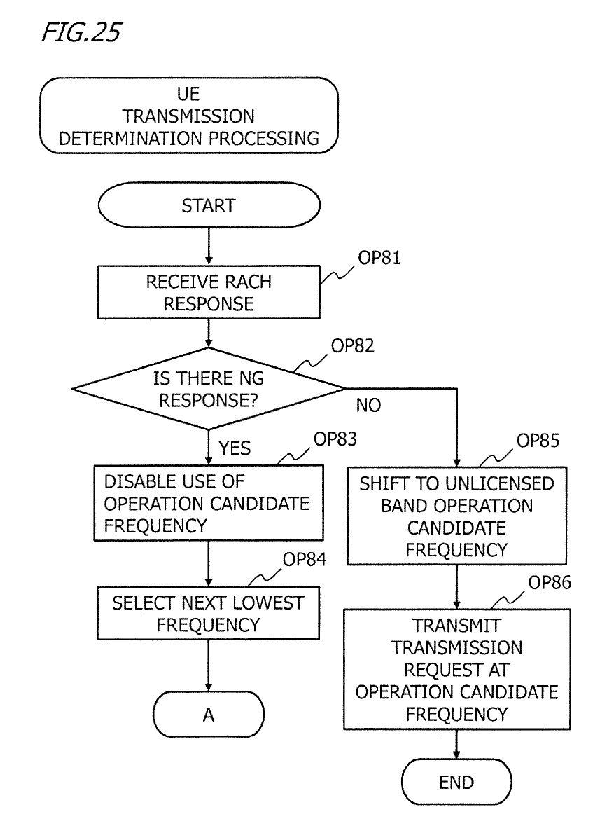

FIG. 25 is an example of a flowchart of transmission determination processing executed by the UE 1 according to the fifth embodiment. The transmission determination processing illustrated in FIG. 25 is processing corresponding to “determination 4” in S18 in FIG. 4 of the first embodiment. The processing illustrated in FIG. 25 is started when the UE 1 receives a RACH trigger response.

In OP81, the unlicensed radio control unit 13 receives a RACH trigger response until a predetermined time elapses after the process starts. The predetermined time is, for example, a time period until the next random access occurs. When the peripheral base station 3 in addition to the serving base station 2 exists, the UE 1 receives at least two RACH trigger responses. Next, the process proceeds to OP82.

In OP82, the unlicensed radio control unit 13 determines whether or not some of the received RACH trigger responses include NG responses. When the received RACH trigger responses include NG responses (OP82: YES), the process proceeds to OP83. When all the received RACH trigger responses are OK responses (OP82: NO), the process proceeds to OP85.

In OP83, since some of the received RACH trigger responses include NG responses, the unlicensed radio control unit 13 determines that the operation candidate frequency is “unusable.” Next, the process proceeds to OP84.

In OP84, the unlicensed radio control unit 13 selects a frequency next lowest to the current operation candidate frequency as a new operation candidate frequency. Next, the process proceeds to OP15 in FIG. 13 and processing on the new operation candidate frequency starts from the unlicensed band interference determination processing.

In OP85, since all the received RACH trigger responses are OK responses and it is indicated that there is no radio wave interference at the operation candidate frequency, the unlicensed radio control unit 13 determines that the frequency shifts from the licensed band frequency currently being used for communication to the unlicensed band operation candidate frequency. Next, the process proceeds to OP86.

In OP86, the unlicensed radio control unit 13 instructs the data processing unit 16B to transmit an unlicensed transmission request to the serving base station 2 about the unlicensed band operation candidate frequency. After that, the data processing unit 16B transmits an unlicensed transmission request about the unlicensed band operation candidate frequency and the processing illustrated in FIG. 25 ends.

The UE 1 performs the transmission determination processing illustrated in FIG. 25, and it is thereby possible to avoid radio wave interference of the unlicensed band even when a frequency shift is made from the licensed band to the unlicensed band.

Note that when the UE 1 is provided with a VCO and processes signals of the licensed band and the unlicensed band through one radio RF unit while adjusting the frequency band using the VCO, the processing of a frequency shift from the licensed band to the unlicensed band is performed by the unlicensed radio control unit 13 controlling the VCO and switching the processing entity from the RF unit 15A to the RF unit 15B.

According to the disclosed radio communication system, radio communication apparatus, base station and radio communication method, it is possible, when carrying out radio communication at an unlicensed band frequency, to avoid radio wave interference caused by collision of unlicensed band operating frequencies between base stations.

<Recording Medium>

A program for causing a computer or another machine or apparatus (hereinafter, “computer or the like”) to provide any of the above-described functions can be recorded into a recording medium that can be read by a computer or the like. The program in the recording medium is read into the computer or the like and executed, enabling provision of the function.

Here, the recording medium that can be read by the computer or the like refers to a non-temporary recording medium that can store information such as data and/or programs by means of electrical, magnetic, optical, mechanical or chemical action and can be read from the computer or the like. From among such recording mediums, ones that can be removed from the computer or the like include, for example, a flexible disk, a magneto-optical disk, a CD-ROM, a CD-R/W, DVD, a Blu-ray disk, a DAT, an 8 mm tape and a memory card such as a flash memory. Also, recording mediums fixed to the computer or the like include, e.g., a hard disk and a ROM (read-only memory). Furthermore, a SSD (solid state drive) can be used as either a recording medium that can be removed from the computer or the like or a recording medium fixed to the computer or the like.

All examples and conditional language provided herein are intended for the pedagogical purposes of aiding the reader in understanding the invention and the concepts contributed by the inventor to further the art, and are to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A radio communication system comprising:
a radio communication apparatus that can carry out radio communication at frequencies in a predetermined licensed band and an unlicensed band; and
a base station that can carry out radio communication with the radio communication apparatus at the frequencies in the predetermined licensed band and the unlicensed band,
wherein
the base station includes a first processor configured to:
manage operating states of frequencies in the unlicensed band; and
notify the radio communication apparatus of operating states of the frequencies in the unlicensed band using a frequency in the predetermined licensed band, and
the radio communication apparatus includes a second processor configured to:
receive the operating states of the frequencies in the unlicensed band from the base station at the frequency in the predetermined licensed band;
select an unused frequency in the unlicensed band as an operation candidate frequency based on the operating states of the frequencies in the unlicensed band; and
transmit a transmission request to the base station at the operation candidate frequency in the unlicensed band.

2. The radio communication system according to claim 1,
wherein the second processor of the radio communication apparatus is configured to transmit an operation request about the operation candidate frequency at the operation candidate frequency in the unlicensed band,
the first processor of the base station is configured to:
receive the operation request about the operation candidate frequency from the radio communication apparatus at the operation candidate frequency in the unlicensed band; and
transmit, when execution of a process associated with transmission of the operation candidate frequency is currently underway, a response of rejection of use in response to the operation request to the radio communication apparatus at the operation candidate frequency in the unlicensed band, and
the second processor of the radio communication apparatus is configured to, when no response of rejection of use in response to the operation request is received from any of the base station and another base station which can carry out radio communication at the frequencies in the unlicensed band, a transmission request to the base station at the operation candidate frequency in the unlicensed band.

3. The radio communication system according to claim 1,
wherein the second processor of the radio communication apparatus is configured to transmit the transmission request to the base station using the operation candidate frequency in the unlicensed band and transmit a transmission disabling request to disable transmission of a radio signal to the other base station at the operation candidate frequency, and
transmit, when transmission of the radio signal at the operation candidate frequency is stopped, a transmission disabling cancellation notice to cancel transmission disabling to the other base station at the operation candidate frequency using the operation candidate frequency in the unlicensed band.

4. The radio communication system according to claim 3,
wherein upon receiving the transmission disabling request from a second radio communication apparatus that carries out communication with the other base station, the first processor of the base station is configured to record in a storage, information indicating that the operation candidate frequency is being used by a base station other than the own station, and
notify the radio communication apparatus of operating states of frequencies in the unlicensed band by the own station and the base station other than the own station based on the storage using the frequency in the predetermined licensed band.

5. The radio communication system according to claim 1,
wherein when a data processing amount associated with communication at the frequency in the predetermined licensed band exceeds a predetermined value, the second processor of the radio communication apparatus is configured to determine to perform communication at a frequency in the unlicensed band and is configured to select the operation candidate frequency in the unlicensed band.

6. The radio communication system according to claim 1, wherein the first processor of the base station is configured to determine, when the data processing amount associated with communication at the frequency in the predetermined licensed band exceeds a predetermined value, to perform communication at a frequency in the unlicensed band and is configured to notify the radio communication apparatus of starting of communication at the frequency in the unlicensed band.

7. The radio communication system according to claim 1,
wherein the second processor of the radio communication apparatus is configured to transmit a transmission stop request to stop the transmission at the operation candidate frequency in the unlicensed band at which transmission of a radio signal is started by the transmission request, and
the first processor of the base station is configured to execute a process of stopping transmission of a radio signal at the operation candidate frequency when the transmission stop request is received and when there is no radio communication apparatus that carries out communication at the operation candidate frequency other than the radio communication apparatus.

8. A radio communication apparatus that can wirelessly communicate with a base station at frequencies in a predetermined licensed band and an unlicensed band, comprising a processor configured to:
receive from the base station, operating states of frequencies in the unlicensed band at a frequency in the predetermined licensed band;
select an unused frequency in the unlicensed band as an operation candidate frequency based on operating states of the frequencies in the unlicensed band; and
transmit a transmission request to the base station at the operation candidate frequency in the unlicensed band.

9. A radio communication method for a radio communication system comprising a radio communication apparatus that can carry out radio communication at frequencies in a predetermined licensed band and an unlicensed band and a base station that can carry out radio communication with the radio communication apparatus at frequencies in the predetermined licensed band and the unlicensed band, the method comprising:
the base station:
managing operating states of frequencies in the unlicensed band; and
notifying the radio communication apparatus of operating states of frequencies in the unlicensed band at a frequency in the predetermined licensed band, and
the radio communication apparatus:
receiving operating states of frequencies in the unlicensed band from the base station at the frequency in the predetermined licensed band;
selecting an unused frequency in the unlicensed band as an operation candidate frequency based on the operating states of the frequencies in the unlicensed band; and
transmitting a transmission request to the base station at the operation candidate frequency in the unlicensed band.
